(19) United States
(12) Patent Application Publication
(10) Pub. No.: US 2013/0204746 A1
(43) Pub. Date: Aug. 8, 2013

(54) AUTOMATIC WEB PRESENCE FEATURE DEPLOYMENT

(71) Applicant: Endurance International Group, Inc., Burlington, MA (US)

(72) Inventors: James Christopher Lee, Highland, UT (US); Benjamin John Merrill, Park City, UT (US)

(73) Assignee: ENDURANCE INTERNATIONAL GROUP, INC., Burlington, MA (US)

(21) Appl. No.: 13/739,968

(22) Filed: Jan. 11, 2013

Related U.S. Application Data
(60) Provisional application No. 61/585,604, filed on Jan. 11, 2012.

(51) Int. Cl. G06Q 30/06

(52) U.S. Cl. CPC G06Q 30/0625
USPC 705/26.62

(57) ABSTRACT

An app store provides a searchable catalog of selectable elements representing programs that provide capabilities for enabling the online presence of a customer, and automatically installs such programs and enables such web presence-enabling capabilities upon selection by the customer of the selectable element.

### CROSS-REFERENCE TO RELATED APPLICATIONS

This application claims the benefit of U.S. provisional patent application Ser. No. 61/585,604 filed Jan. 11, 2012, which is hereby incorporated by reference in its entirety.

### BACKGROUND

1. Field of the Invention

The present invention relates to providing web presence services via automated remote web presence maintenance services.

2. Description of the Related Art

Delivery of web site and web hosting services is fragmented and generally requires a user to separately identify and take several distinct steps, mostly by trial and error, to establish a new web presence or to update an existing presence, generally resulting in at least some portion of the web presence being incomplete. Access to web presence programs are equally fragmented and often require unique registration for each program.

### SUMMARY OF THE INVENTION

The methods and systems of automated program deployment described herein may facilitate developing access channels and/or access points for existing and potential customers of a web presence hosting business. Each of such customers of the web presence hosting business may itself have an online presence, hosted by the hosting business, such as a website, a blog, a portal, a presence on a social networking site, such as LinkedIn®, Facebook® or Twitter®, or the like (such presence of any type being generally referred to herein except where context indicates otherwise, as a “web presence”). By providing one-click style program deployment of essential, interesting, and/or valuable web presence features at little or no cost to businesses or other users that would benefit from improved web presence, such users of such a service may be presented with a variety of different offerings by the web presence hosting business. In an example, a web hosting service provider may offer such a service to attract new customers to the web hosting service by initiating contact with the potential new customer based on the new customer's interest in establishing or enhancing a web presence. In the example, a user of such a service may select to start blogging. As a result of the selection to start blogging, the user may be offered to have a website for the user's blogs automatically established along with a web hosting service for the website and blog. The outcome of such an interaction may be that the user is provided the desired blogging features along with a web hosting contract through which the blog will be made available on the Internet. If the user already has a preferred venue for the blog (e.g. the user has an existing website), the blog web presence feature may be automatically added to the user's website upon receipt of the website details from the user.

In the methods and systems of automated web presence program maintenance described here, the methods and systems may include an app store that may provide a searchable catalog of selectable elements. The selectable elements may represent programs that may provide capabilities for enabling an online presence of a customer. The app store may automatically install such programs and enable such web presence-enabling capabilities upon selection by a customer of the selectable element. The app store may be an electronic on-line accessible app store. The app store may include the electronically searchable catalog of the selectable elements representing web presence programs that may provide capabilities for enabling online presence of the customer. The app store may also include a web presence program maintenance facility that may automatically install a selected portion of the programs and may enable at least one web presence-enabling capability for each installed program in response to user confirmation of a selection of a selectable element. The online presence may include a capability to communicate over a network. The selection may include at least one of a single clicking, double clicking, selection in a drop down menu, selection of an icon, and touching an icon. The app store may be configured to automatically collect customer website hosting information to facilitate installation. The automatic collection of customer website hosting information may be based on information provided by a source that provides a reference of the app store to the customer. The reference to the customer website hosting information may be provided by the source through an on-line referral. The source may be a website hosting provider. The searchable catalog may be provided based on customer-specific information. The searchable catalog may be provided based on advertiser fees received for placement of at least one of the selectable elements. The searchable catalog may be provided based on a source that provides a reference of the app store to the customer. At least one of the selectable elements may represent a web presence theme. The theme may require at least one web presence program represented in the catalog to be installed prior to installing the theme.

In the methods and systems of automated web presence program maintenance described here, the methods and systems may include a method that may include receiving information from the user for configuring at least a portion of the selectable elements for installation in a web presence hosting environment. Each of the selectable elements may represent a different web presence type, and each selectable element may be adapted to automatically generate a fully operational web presence of the type associated with the selectable element upon selection by a customer whose web presence information may be electronically accessible during an automatic web presence generation. The method may further include receiving a user selection of one of the selectable elements. The method may also include automatically generating, without further user action, a fully operational web presence of a web presence type associated with the selectable element selected by the user. The catalog may be searchable. The automatic generation of the fully operational web presence may involve at least one of purchasing a domain name, transferring a domain name, purchasing web hosting, and generating a webpage.

In the methods and systems of automated web presence program maintenance described here, the methods and systems may include a method of automated web presence feature installation. The method may include receiving a web presence feature recommendation for a user. The method may also include selecting a web presence program from a searchable catalog of selectable elements representing programs that may provide capabilities for enabling an online presence of a customer. The method may further include processing a script for configuration and installation of a selected web presence program. The method may also include enabling an installed web presence program. The selection of the web presence program from the searchable catalog may be based on the web presence recommendation for the user. The web presence recommendation may be based on an analysis of social network presence of the user. The web presence recommendation may be based on an industry of the user. The web presence recommendation may be based on job duties of the user. The method may also include ensuring that prerequisite programs are installed prior to installation of the selected web presence program. The ensuring that prerequisite programs are installed may include installing automatically prerequisite programs prior to installation of the selected web presence program.

In the methods and systems of automated web presence program maintenance described here, the methods and systems may include a method of automated web presence enablement. The method may include receiving a user's web presence information from a web presence host that hosts at least a portion of the user's web presence. The method may also include configuring a script server to install at least one web presence feature based on the received information. The method may further include enabling the at least one web presence feature for use by the web presence host in delivering web presence services for the user. The at least one web presence feature may be selected from a searchable catalog of selectable elements representing programs that provide capabilities for enabling online presence of the user or a customer.

In the methods and systems of automated web presence program maintenance described here, the methods and systems may include a method of automatically updating hosted files. The hosted files may be used to enable a user's web presence. The method may include receiving an indication of availability of an improvement for at least one web presence capability of a user. The method may also include accessing a hosted file that enables the at least one web presence feature for the user. The method may further include updating the hosted file to enable the improvement for the at least one web presence capability. The updating may include revising a portion of the hosted file to facilitate presentation of improved web presence features on a web browser. The updating may also include adding a web page to a website comprising the hosted file.

In the methods and systems of automated web presence program maintenance described here, the methods and systems may include a method of automatically updating a website hosting account. The method may include receiving website hosting account information that references a plurality of web presence features. The method may also include receiving an indication that a new web presence feature is adapted to be automatically enabled for the website hosting account. The method may further include automatically updating the website hosting account to include the new web presence feature. The method may further include associating a service fee for the web presence feature with the account. The method may also include notifying an owner of the website hosting account of the new web presence feature in the updated website hosting account.

In the methods and systems of automated web presence program maintenance described here, the methods and systems may include a method of automatically configuring and installing an app store. The app store may provide a searchable catalog of selectable elements representing programs that may provide capabilities for enabling an online presence of a customer so that the app store may be accessible through a predetermined website. The method may include receiving a reference to a target website for hosting a web presence program app store. The method may also include accessing a web presence program library. The method may further include determining selectable elements for at least a portion of web presence programs in the web presence program library. The method may also include receiving app store configuration data that includes rules for configuring the selectable elements. The rules may be based in part on information associated with the target website. The method may further include configuring a web presence program installation package for automatically installing the app store that provides a searchable catalog of the selectable elements representing programs that provide capabilities for enabling online presence of a user. The installation package may include at least two of the selectable elements, the app store configuration data, the reference to the target website, app store application programming interfaces (APIs,) and a web page location for locating the app store within the target website. The method may also include installing the app store.

In the methods and systems of automated web presence program maintenance described here, the methods and systems may include a method of ingesting web presence programs for representation in a searchable catalog of selectable elements representing programs that may provide capabilities for enabling an online presence of a customer. The method may include receiving a candidate web presence program installation package in an app store ingestion facility. The method may also include automatically validating the candidate package against a web presence program packaging standard with the ingestion facility. The method may further include based on the validation, performing at least one of automatically accepting the candidate package to be included in the catalog and automatically rejecting the candidate package. The packaging standard may require a candidate program to enable automatic installation of the program and automatic enabling of at least one web presence feature provided by the program.

In the methods and systems of automated web presence program maintenance described here, the methods and systems may include a web presence administration user interface for presenting information representing web presence features selected from a searchable catalog of selectable elements representing programs that may provide capabilities for enabling an online presence of a customer, recommendations of additional web presence features, and configuration control of web presence programs installed through the selectable catalog. The user interface for web presence administration may include an electronic display of information representing web presence features selected from a searchable catalog of selectable elements representing programs that provide capabilities for enabling online presence of a customer. The user interface may also include user selectable recommendations of additional web presence features. The user interface may further include a user interface to allow a user to control configuration of web presence programs installed through the selectable catalog.

In the methods and systems of automated web presence program maintenance described here, the methods and systems may include a system that may include temporary remote helper application programming interface (API) components for performing a web presence maintenance function. The remote helper API components may perform a web presence maintenance function that may be deployed on a target website hosting server by a remote web server. The remote web server may be configured to facilitate maintenance of a web presence program that may be represented as a selectable element in a catalog of selectable elements for enabling an online presence of a user by installing and invoking at least one of the plurality of temporary remote helper API components on the target web presence hosting server in response to a request for web presence maintenance. At least one of the plurality of web presence maintenance functions may include determining a suitability of a target server environment for installation of the web presence program. The at least one of the plurality of web presence maintenance functions may include configuring the target server for deployment of the web presence program. The at least one of the plurality of web presence maintenance functions may include at least one of maintenance and removal of a presence program that is installed in the target server environment. The at least one of the plurality of web presence maintenance functions may include detecting installed web presence programs and determining compatibility of at least one installed web presence program for inclusion in a remote management scheme that facilitates management of web presence programs represented in the catalog of selectable elements representing web presence programs for enabling an online presence of a user.

In the methods and systems of automated web presence program maintenance described here, the methods and systems may include a method of simulated-user installation wizard automation. The present disclosure may provide a method of automatically installing a web presence program. The method may include deploying a temporary remote helper application programming interface (API) on a website hosting server for performing a trial installation of the web presence program. The method may also include collecting user interaction during a trial installation of a web presence program on the website hosting server via the temporary remote helper API. The method may further include configuring elements in an activity record based on user interaction and hosting server activity during the trial installation. The method may also include dynamically accessing the elements in the activity record and the web presence program configuration data to facilitate automated installation of the web presence program. The temporary remote helper API facilitates collection of user and website hosting server information for use in the trail installation to facilitate reducing user interactions. The facilitation of automated installation of the web presence program may include automatically installing the web presence program on the website hosting server.

In the methods and systems of automated web presence program maintenance described here, the methods and systems may include a method of real-time feedback to a user from a distributed web presence program installation process queuing system. The disclosure may provide a method of remote maintenance of a web presence program. The method may include receiving a request for remote maintenance of the web presence program selected from a catalog of selectable elements representing web presence programs for enabling an online presence of a user. The method may also include generating a series of tasks to be performed in a particular order to satisfy the request for remote maintenance of the web presence program. The method may further include distributing the series of tasks to a plurality of networked servers that communicate over a network to ensure the tasks are performed in a particular order. The method may also include presenting a real-time status of the remote maintenance of the web presence program to the user by polling at least a portion of the plurality of networked servers to determine task progress and presenting the task progress in a web presence program maintenance user interface. The tasks are consumed by the plurality of network servers into a task processing queue that includes tasks for satisfying a plurality of remote maintenance requests and that performs first-in-first-out execution of tasks in the queue.

In the methods and systems of automated web presence program maintenance described here, the methods and systems may include a method for adopting pre-existing installations into simple scripts management scheme. The method may update a user's web presence library with references to web presence programs. The method may include deploying a temporary web presence helper application programming interface (API) component on a website hosting server. The method may also include detecting installed web presence programs associated with a website hosting user with the helper API. The method may further include determining suitability of at least one installed web presence program for inclusion in a remote management scheme that facilitates management of web presence programs represented in a catalog of selectable elements representing web presence programs for enabling an online presence of a user. The method may also include updating the website hosting user's web presence program library with references to installed web presence programs that are determined to be suitable for inclusion in the remote management scheme.

In the methods and systems of automated web presence program maintenance described here, the methods and systems may include a method for simultaneously installing a plurality of web presence programs into a single hosted environment to enhance a user's web presence. The method may include dynamically configuring non-conflicting names of application programming interface (API) components. The method may also include deploying the API components for temporary execution on a website hosting server. The method may further include performing with the deployed API components at least one web presence maintenance function for the plurality of web presence programs that are represented by selectable elements in a catalog of selectable elements for enabling an online presence of a user, the at least one web presence maintenance function selected from a list containing installation, configuration, upgrade, and uninstallation. The deployed API components self-destruct upon completion of the at least one web presence maintenance function.

### BRIEF DESCRIPTION OF THE FIGURES

In the figures, which are not necessarily drawn to scale, like numerals may describe substantially similar components throughout the several views. Like numerals having different letter suffixes may represent different instances of substantially similar components. The figures illustrate generally, by way of example, but not by way of limitation, certain embodiments discussed in the present document.

FIG. 1 depicts a web presence program storefront embodiment of the automatic application installation/deployment methods and systems described herein;

FIG. 2 depicts exemplary catalog presentations that may be based on information known about a user;

FIG. 3 depicts a step of allowing the user to select an item in a web presence program catalog;

FIG. 4 an alternative and/or additional step of automatically accessing configuration information from the user's web presence information;

FIG. 5 depicts a step of automatically updating relevant hosted files that are used to enable the user's web presence;

FIG. 6 depicts a step of automatically completing the establishment of the web presence;

FIG. 7 depicts a web presence store with associated APIs;

FIG. 8 depicts a web presence installation architecture;

FIG. 9 depicts a flow chart of a method for automatic configuration and installation of an app store;

FIG. 10 depicts a flow chart of a method of ingesting web presence programs for representation in a searchable catalog of selectable elements;

FIG. 11 depicts a flow chart of a method for automating a simulated user installation wizard;

FIG. 12 depicts a flow chart of a method for providing a real-time feedback to a user from a distributed web presence program installation process queuing system;

FIG. 13 depicts a flow chart of a method for adopting a plurality of pre-existing installations into a web presence program management scheme; and

FIG. 14 depicts a flow chart of a method for simultaneously installing a plurality of web presence programs into a single hosted environment.

### DETAILED DESCRIPTION

The methods and systems of automated application deployment described herein may provide a distribution platform for applications, web presence features, add-ins, upgrades, and the like. Such a platform may provide value to a wide range of software, web presence, web hosting, and other related vendors through the platform's capabilities to provide one-click or other streamlined access to important, interesting, and/or valuable features that enhance web presence of a user. Features may include professional cloud storage for backup and the like; blog applications (e.g. premium WORDPRESS themes, WORDPRESS, CHYRP CMS, B2EVOLUTION, TEXTPATTERN, NUCLEUSCMS, GEEKLOG, and the like); business tools (e.g. MAJOR UPTIME website monitoring, VoIP phone services, and the like); classifieds; education (e.g. MOODLE, CHAMILO, and the like); forms and surveys (e.g. LIMESURVEY, PHPFORM GENERATOR, ADVANCEPOLL, and the like); forums (e.g. SIMPLE MACHINES FORUM, PHPBB, BBPRESS, PUNBB, VANILLA FORUMS, and the like); client management (e.g. QUICKBOOKS, SUGARCRM, FENG, FRONT ACCOUNTING, VTIGERCRM, SIMPLE INVOICES, and the like); guestbooks (e.g. GBOOK, LAZARUS, and the like); help center (e.g. OSTICKET, HELP CENTER LIVE; CRAFTY SYNTAX LIVE HELP, and the like); live chat (e.g. PHPFREECHAT, X7CHAT, and the like); content management (e.g. JOOMLA, OCPORTAL, DRUPAL, MODX, E107, MAMBO, XOOPS, PHP-NUKE, PHPWCMS, and the like); mailing lists (e.g. ICONTACT, DADA MAIL, PHPLIST, POMMO, and the like); photo galleries (e.g. COOPERMINE, GALLERY, ENPHOTO, PIWIGO, PIXELPOST, 4IMAGES, and the like); eCommerce (e.g. IPAYMENTS, SHOPSITE, PRESTASHOP. AVACTIS, MAGENTO, CUBECART, OSCOMMERCE, ZEN CART, AGORACART, OPENCARD, TOMATOCART, and the like); product sourcing (e.g. DOBA DROP SHIPPING, and the like); project management (e.g. BASECAMP, MANTIS, PHPROJEKT, and the like); rss (e.g. GREGARIUS, SIMPLEPIE, and the like); security (e.g. SITELOCK, and the like); social networking (e.g. PLIGG, ELGG, OXWALL, and the like); statistics (e.g. PIWIK, and the like); utilities (e.g. PHPMYFAQ, WEBCALENDAR, PHPGEDVIEW, GCOUNT, and the like); webmail (e.g. BIGSENDERS, ROUNDCUBE, and the like); website builders (e.g. AMAZING WEB TEMPLATES, LIVESITE, SOHOLAUNCH, BASICPAGES, CONCRETES, ZAZAVI, and the like); website design (e.g. GLOWTOUCH TECHNOLOGIES, INFINITE WEB SOLUTIONS, and the like); wikis (e.g MEDIAWIKI, TIKI WIKI CMS GROUPWARE, WIKKAWIKI; DOKUWIKI; PMWIKI, and the like).

The methods and systems of automatic application installation and deployment may also be integrated with other front-end systems and functions to provide robust installation and deployment of features. Such a system may work “in the background” to handle the configuration, installation, and activation of features offered by the front-end system. In an example, a web hosting front-end system client may choose to add a security feature for the websites that are hosted by the front-end system. Although the client may use the web hosting front-end system to request adding the security feature, the front-end system may communicate with the system to configure the security feature on all of the client's web sites. In this way, the automatic application installation and deployment methods and systems described herein can be extended to satisfy a variety of user needs. In this example, the user (the web hosting client) needed to add security to each of his hosted websites, but only had to indicate this need and the front-end system applied its knowledge of the client's websites to work cooperatively with the system to meet the client need. The communication between a front-end system and the systems described herein may be via an application programming interface, or the like.

Similarly, the methods and systems described herein may be used with an application store concept that may be operated as a standalone function or may be integrated with another system. In this way, the features of the other system can be presented to the other system users via the application store concept for one-click type installation and activation. In an example, a web hosting system may offer a variety of features (hosting plans, email services, website security, shopping cart, and any other feature, including the features identified herein). These features may be presented to the web hosting system client via an app storefront of the application installation and deployment methods described herein. The app storefront may be branded to appear as if it is a storefront of the web hosting system. When a client of the web hosting system selects a feature from this app storefront, the information known about the web hosting client may be accessed and used to enable automatic installation, deployment, activation, and customization of the selected feature for the client. Further in the example, the web hosting client may select to add a live customer support chat feature to her hosted website. Information about the customer (e.g. a logo, hours of operation, and the like) may be gathered (e.g. from the hosted website) along with information relevant to the web hosting provider (e.g. service level, and the like) and used to configure the live chat feature for deployment on the web hosting client's website.

The app storefront concepts described herein may alternatively be used as a channel for making relevant upsell offers to customers of a web presence hosting service provider. A few such upsell examples include: (i) whenever a user chooses to deploy a blogging feature through the app storefront, the user may be offered something relevant such as a premium template for the blog; (ii) whenever a user chooses to deploy a shopping card feature, the user may be offered something relevant such as secure payments via SSL; and (iii) whenever a user chooses to deploy a communication feature or a content feature, such as web-based email or a set of new pages, the user may be offered a relevant feature, such as the opportunity to present targeted banner ads within email, creating a revenue stream for the user and the web hosting service provider.

The methods and systems described herein may also include providing an application store that provides a searchable catalog of selectable elements representing programs that provide capabilities for enabling a web presence of a customer; automatically installing software derived from the programs; and enabling the capabilities for enabling a web presence upon selection by the customer of a selectable element. In a variation of the methods and systems, the web presence of a customer includes only the capability to communicate over a network. In the methods and systems, selection by the customer includes at least one of single clicking, double clicking, selection in a drop down menu, selection in a pop-up menu, at least a single click followed by at least a single confirmation click in a pop-up window, and the like.

The methods and systems related to an application store may further facilitate allowing individuals to offer web presence capability applications in an app store. An individual, team, or business may produce a web presence-related capability (e.g. an accounting application) that could be offered for sale through the application store. In this way, a variety of disparate feature providers may be enabled to offer services and/or products to a variety of users. Such an arrangement may facilitate revenue sharing among an operator of the application store and the feature providers. In an web hosting provide example, affiliates of the web hosting provider may share revenue from sales of features through a application store operated by the affiliates with the web hosting provider.

Applications may be developed by third parties to be offered in the app store described herein according to a packaging standard that may be published by an operator, developer, owner, or other associated of the app store. Developers who which to deploy a web presence element (e.g. application) through the methods and systems described herein may be required to use such a packaging standard. Objectives of such a packaging standard may include allowing for at least basic automated installation by the methods and systems described herein without requiring substantive building of the application after it has been submitted to the app store to be offered through the app store. This may facilitate easier ingestion, testing, and targeting of installations of applications submitted by third parties to the app store. Internal app store developers and others who may be interested in participating in the automated web presence/enablement methods and systems described herein may also find it beneficial to adhere to such a publishing standard.

A web presence program packaging standard may require that a program package may be in an archive format (e.g., tar, tar.gz, zip, and the like) developed using well known archive technologies either alone or in combination with the well known compression technologies. To facilitate automated installation on a target server, the archive may require an index.php or index.html file located at the root directly of the archive.

In an example, the files that may be provided for the web presence program may be stored in a root directory of the archive and the package may be configured to include a database file (e.g., a mysql database file named as a data.sql) in the root directory of the archive. The database file may be configured to include an entire database structure that may be required to enable execution of the web presence program on the hosting server. In addition, sample data may be provided in the archive format of the package. An exemplary sample data file may be created as sample data.sql and made available in the archive format.

The archive may be organized so that the following files are located in the following order: sql data file, index.php file, license.txt file, readme.html file (help file optional), additional files.

The methods and systems described herein may be configured to create a copy of a given script package associated with a respective web presence program and divide the script package in different (e.g., three) portions. The first portion of the script package may include script files that may be configured to include instructions to enable deployment of a particular web presence program. The second portion of the script package may include a database as a SQL dump in the form of data.sql for providing an initial table structure. A sample data.sql may also be provided with additional SQL data that may include available module activation information, and the like. The user may choose whether or not to include the sample data during installation of the script package on the hosting server. The third portion of the script package may include configuration files that may include standard configuration options and database connection details.

The method and systems described herein may enable updating of values in the database and configuration files using a standard set of keyword tags. The updated files may be delivered to the target hosting server as carbon copies. As a result, the process of version compatibility checking may become simpler and the system may become more robust and efficient

The methods and systems described herein may enable the user to update the existing web presence program on the target hosting server to facilitate web presence using the updated features of the web presence program. The updating may take place in two stages. The first stage may include updating of file system updates that may be in the form of a patch archive built from a list of changed files from a previous version of the web presence program. The second stage may include updating of the database. The database updating may happen in a plurality of different ways. One way may include delivering a SQL difference file that may include changes in the form of modified structure. Alternatively, a database update page (e.g., a php page) may be delivered to provide updates in the database.

The methods and systems described herein may be configured to include a plurality of keyword tags that may be used in the database and configuration files of the package of the web presence program. The plurality of keyword tags may be categorized to efficiently manage functionalities associated with the respective keyword tags. The categorized tags may include but are not limited to path based tags, database tags, admin tags, and other additional tags. In an example, the database tags may be a ss_dbhost tag for identifying a host name of the mysql database server, a ss_dbuser tag for identifying a database username, a ss_dbpass tag for identifying database password assigned to the given username, a ss_dbname tag for identifying a database name, a ss_dbprefix tag for identifying a database table prefix, a ss_dbtype for future use and the like. In another example, the admin tags may include a ss_admin user tag for identifying admin username as specified by the user, a ss_admin_pass tag for identifying an encrypted admin password as specified by the user, a ss_admin salt tag for identifying a salt used to generate the admin password, if required, a ss_admin_pass_plain tag for identifying plain admin password as specified by the user and the other tags.

The methods and systems described herein may also include presenting a customer with a catalog of selectable elements, each representing a different web presence type, and where each selectable element is adapted to automatically generate a fully operational web presence of the type selected after collecting customer information. The catalog of selectable elements may be searchable, sortable, filterable, dynamically generated, and the like. It is envisioned that automatically generating a fully operational web presence involves at least one of purchasing a domain name, transferring a domain name, purchasing web hosting, and generating a webpage.

The methods and systems described herein may further facilitate automatic installation of web-based products or features for new or existing websites. In an example, if a user wants to add blogging capability to a website, include a photo gallery capability, offer a shopping cart for checkout, or make available a customer survey tool, the methods and systems described herein may facilitate automatic installation and update of any of these or other web presence features through a simple clickable interface that requires little more than selecting a feature and providing information about a target website. By selecting a feature and identifying a target website, the selected feature will be automatically added to the target website. Example web-based or web presence features include invoicing solutions, survey tools, calendaring, shopping cart, web builder, search engine optimization add-ins, and the like.

In addition to supporting automatic installation and configuration of web-presence elements into a new or existing web presence (e.g. website), the methods and systems described herein can be used for commercial software product automatic installation, configuration and maintenance, such as for desktop client systems. In an example, if a user wishes to install a new type of search engine capability into his/her desktop client computer, the user may select the new type of search engine from a library of commercial applications in a web browser running on the target desktop client system. As a result of the selection, the new type of search engine may be automatically configured for the desktop client system, installed, and updated to the latest version.

Other embodiments of the automatic application installation and deployment methods and systems described herein may include combining such capability with an engagement engine that provides recommended work flows for enabling web presence features or elements. As an alternate to requiring a user to select a particular application or web-presence feature from an app store, information about who the user is, what the user has done, and what the user desires to do (e.g. start blogging) may be collected. The engagement engine may analyze the gathered information along with other information related to similar users, industry metrics, and the like to recommend a particular application or a set of applications to be automatically installed and deployed. In an example, if a user has an extensive web presence and has previously installed WORDPRESS for blogging on a first website and the user desires to add blogging capability on a second website, the engagement engine in cooperation with the web presence remote maintenance capabilities described herein may recommend WORDPRESS be installed in the second website. Likewise, if a user who desires to start a blog has little or no web presence, the engagement engine may recommend a workflow for creating a basic web presence for the user that includes blogging. Such a basic web presence may also include registering a website with a URL and signing up for a simple hosting package, including email with the blog, and linking to the user's social networking page. The applications to configure and enable this basic web presence may be automatically installed and deployed by the methods and systems described herein.

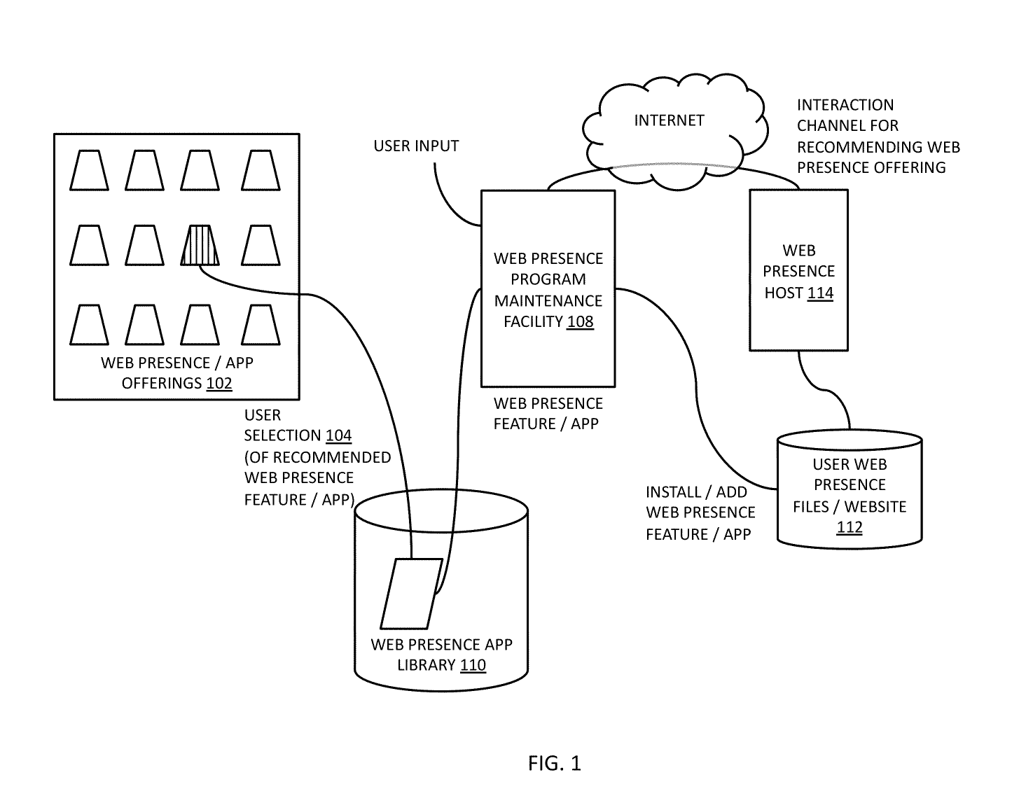

FIG. 1 depicts an application storefront embodiment of the automatic application installation/deployment methods and systems described herein. A user may consider a plurality of web presence/app offerings 102. The user may select a web presence feature 104 that may be recommended via an engagement engine. The selected web presence feature may direct a web presence program maintenance facility 108 to select the software, configuration information, and the like from a web presence app library 110 to install the user selected web feature. The web presence program maintenance facility 108 may configure the web presence software and the like and install it with the users web presence files 112. As described herein, the web presence program maintenance facility 108 may connect and interact with a third party system 114, such as a web presence host, to enhance and extend the web presence remote maintenance capabilities to include recommending apps (e.g. with an engagement engine), facilitating installation of apps for clients of the third party, revenue sharing, upselling, and the like.

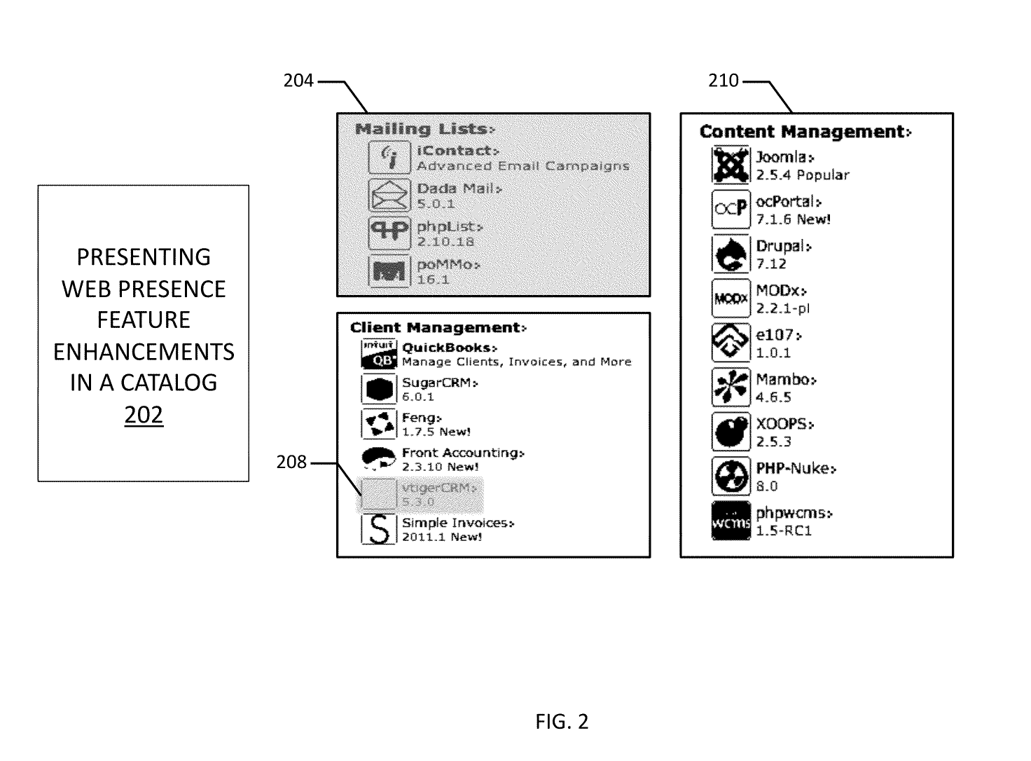

FIGS. 2-6 depict an exemplary step-by-step flow of an instance of (i) presenting web presence feature enhancements in a web catalog; (ii) allowing the user to select an item in the catalog; (iii) upon selection, automatically accessing configuration information from the user's web presence information (eg., the domains, etc.); (iv) using the configuration information, automatically updating relevant hosted files/databases that are used to enable the user's web presence; and (v) automatically completing the establishment of the web presence, including billing the user's account and providing the user with such information as is necessary to maintain the web presence feature.

FIG. 2 depicts the step of (i) presenting web presence enhancement features in a web catalog 202. Exemplary catalog presentations that may be based on information known about a user are also depicted in FIG. 2. A user of the web presence enhancement catalog may be identified at the start of the flow depicted in FIGS. 2-6. A user who may be seeking to enhance his/her web presence may also be a web hosting client. Such a user may access the web presence enhancement catalog through the user's web hosting management interface. Alternatively, the user may identify his/herself at the start of the flow via providing credentials associated with a web hosting account, a user account of the catalog platform, registering with the catalog platform, and the like. In yet other embodiments, the user may be automatically identified via computer/device identifying information that may be included in electronic communications between the user's computer/device and a server hosting the catalog when the user accesses the catalog, and the like. If a user is already identified when this step-by-step flow begins, information about the user's current web presence may be used to guide the presentation of the catalog of web presence enhancement features. In an example of user knowledge driven catalog presentation, it may be automatically determined that the user has an existing mailing list web presence feature on his/her web presence assets (e.g. websites, blogs, etc). Alternatively, it may be determined that the user's current web presence assets may not support mailing list features. It may be determined from a user's preferences that the user does not wish to enable mailing list features. In such scenarios all of the web presence enhancement mailing list enhancement features 204 may be grayed out, indicating, for example that these features are not available. Rather than graying out an entire category of web presence enhancement features, a specific feature may be grayed out in the catalog presentation as depicted in client management 208. This may be for any of the reasons above or for other reasons, such as the user already has the specific feature on his/her website; the feature is not compatible with other features that are already part of the user's web presence; and the like. The content management web enhancement feature category 210 may depict catalog entries from which the user may select any feature. This presentation may be a result of the user not yet being identified to the catalog platform and/or the user's web presence may be enhanced by selection of any of the content management features 210.

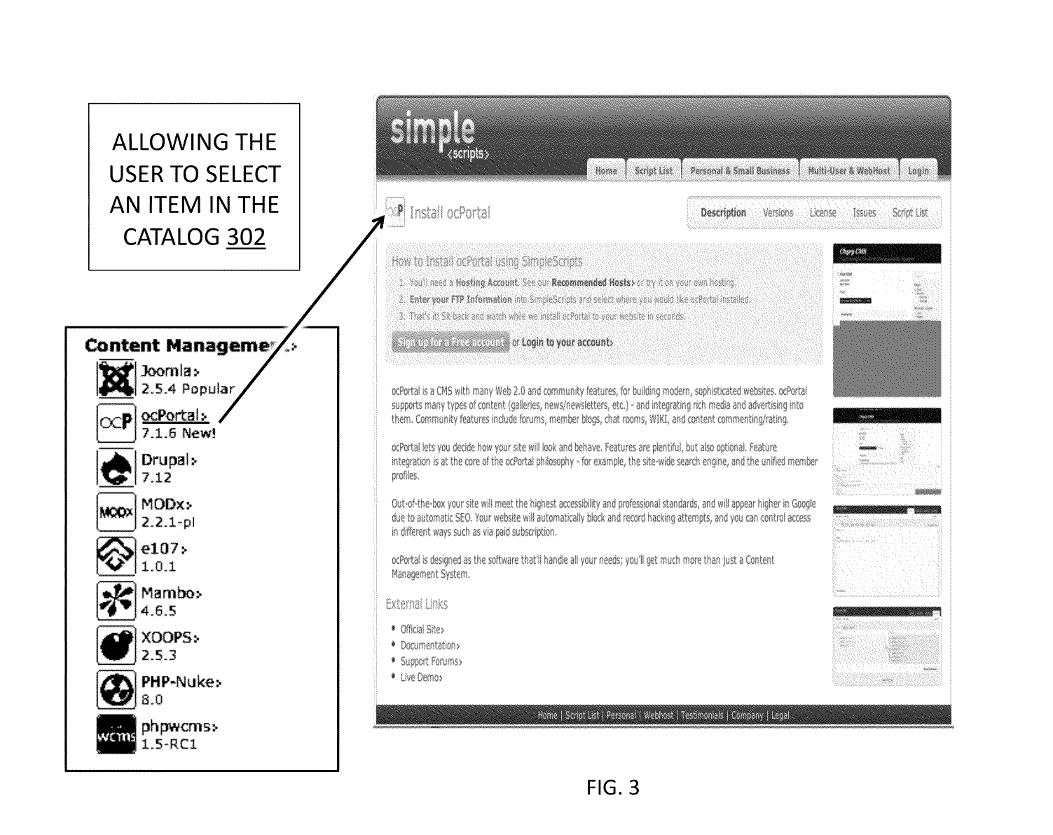

FIG. 3 depicts a step of allowing the user to select an item in the catalog 302. A user may view the web presence enhancement features in the catalog and may select one, such as by clicking on it as depicted in FIG. 3. Selection of the web presence enhancement feature “ocportal” may result in the user's web browser being directed to an ocportal installation page 304. In the event that the user is already identified, such as described above with respect to step 202 in FIG. 2, the ocportal installation page 304 may include user identification information along with instructions for proceeding with installation of the ocportal web presence enhancement feature. The user may also be presented with information about his/her current web presence assets to facilitate installation of ocportal. In an example, a user may be presented with a list of the user's web sites based on the user identification that they user may optionally accept for receiving an installation of ocportal. In the event that the user has not yet been identified, the ocportal installation page 304 may request such identification by asking the user to enter login credentials, web hosting account information, and the like.

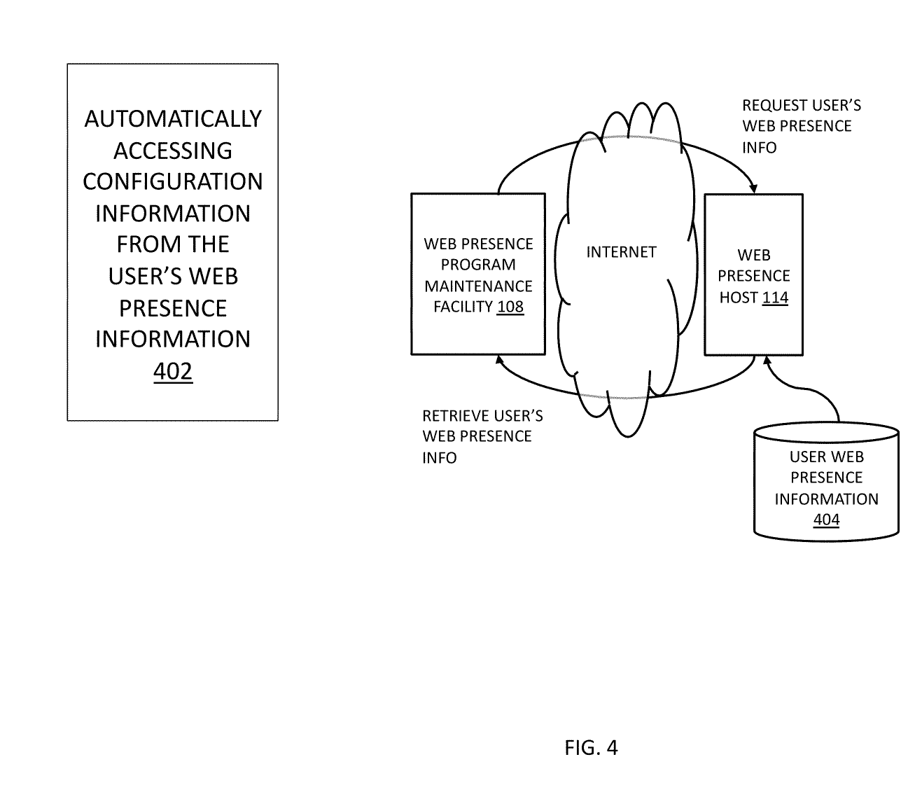

FIG. 4 depicts an alternative and/or additional step of automatically accessing configuration information from the user's web presence information 402. Step 402 may occur before, during, or after step 302 that is depicted in FIG. 3. Automatically accessing configuration information about the user's web presence may impact step 202, 302, and others. In addition, accessing configuration information about a user's web presence may facilitate determining a path for installation and/or configuring a selected web presence enhancement feature including user preferences (e.g. logos, security, web hosting, hosting/billing account, email address for receiving information about the installation, domains, and the like). In an example of automatic web presence information gathering of FIG. 4, a web presence program maintenance facility 108 may request a user's web presence information 404, such as from a web presence host 114. The server 108 and the web host 114 may communicate through a network, such as the Internet. The web presence program maintenance facility 108 may be given access to the user's web presence information files 404 to facilitate automated installation of the selected web presence enhancement feature.

If it is determined that the user does not have the minimum required web presence features to support automatically installing the selected web presence feature, the user may be offered to have the minimum required web presence features automatically created for the user prior to conducting the installation.

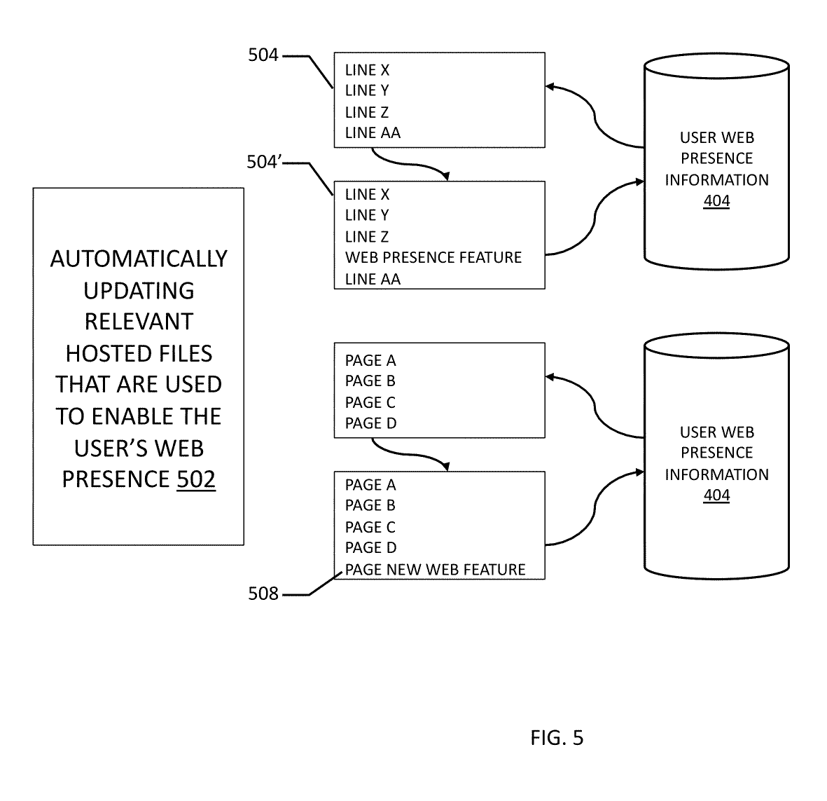

FIG. 5 depicts a step of automatically updating relevant hosted files that are used to enable the user's web presence 502 based on the information gathered in step 402. In the example of automatic updating depicted in FIG. 5, a file containing HTML 504 that is used by a web browser to render a user's web site may be accessed and modified resulting in HTML file 504′ to enable access to the web presence feature. In another website example of automatically updating a user's web presence files 404, a new web page 508 may be added to the website to enable use of the selected web presence enhancement feature. These are merely examples of automatic updating and are not meant to be limiting as a wide range of automatic updating to satisfy feature installation is contemplated and included herein.

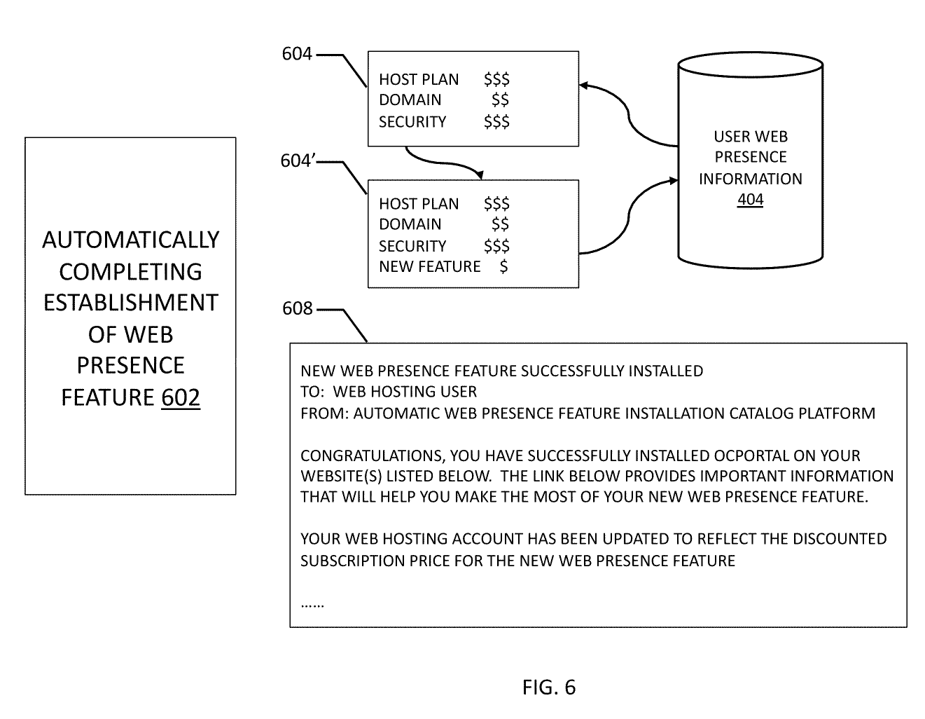

FIG. 6 depicts a step of automatically completing the establishment of the web presence, including billing the user's account and providing the user with such information as is necessary to maintain the web presence feature. Upon confirmation of successful installation of a selected web presence enhancement feature, a user's web hosting account 604 may be updated 604′ accordingly. In an example of automated account updating, an automatic payment amount may be adjusted to cover any startup or recurring costs of using the new web presence enhancement feature. In another example, a user's hosting plan may be adjusted to provide the user with a better price than if the cost of the new web presence feature were merely added to the current hosting plan. In yet another example in which a free web presence feature was successfully installed, a user's account may be updated to reflect the installation date of the web presence enhancement feature. This information may be valuable to retaining the user as a web hosting client because the use of the new feature may be closely monitored for a period of time to ensure that the user is gaining the benefit of the new feature. To start the user on his/her way to effectively using the new web presence feature, an email 608 may be sent to the user to notify the user of the successful installation, provide guidance regarding making the most of the new feature, offering help with the new feature, and making it clear that the user's hosting account bill/features have been properly updated to reflect the addition of the new feature. Completing the establishment of the selected web presence enhancement feature may include processing an updated website and publishing the updated website so that it is visible on the Internet.

The methods and systems described herein, such as for recommending applications and other web presence elements may be adapted to facilitate recommending and ultimately facilitating delivery of advertisements to prospects. The methods and systems that facilitate application recommendation can be used for promoting partners and the like in a targeted way. Likewise, a platform on which an app store as described herein may be based may include techniques for application developers, advertisers, and other web presence enablement vendors to indicate a preference for greater visibility of one or more applications in the app store. Such preference for greater visibility may be augmented by payment of a placement fee that may result in an app being more prominent (e.g. through various visual and/or auditory techniques). When such systems and techniques are combined in various ways a platform as described herein may provide ways of targeting apps, content, advertisements, partners, and the like toward users of the platform based on associations of aspects of the user, a vendor's preference for visibility, and a vendor's ability to pay for such improved visibility.

Visibility improvement may be accomplished as a targeted activity so that vendors who prefer to be made more visible to particular users (e.g. lawyers) may have their apps, content, advertisements, and the like made more visible to lawyers. Likewise if a vendor does not want to pay for improved visibility to certain users, the platform may not make apps for the vendor more visible to these certain users. Examples of improved visibility may include: greater visibility in an app store page through position on the page, app description, text size or color, and a wide variety of other visibility enhancements; multiple placements or preferred placement on screens other than an app store page, such as an advertisement on an installation page of another application. These are just a few examples of visibility enhancement that may be provided.

As noted above, visibility may be targeted toward certain users. Targeting improved visibility may be based on the apps that a user is selecting to install, apps for which a user has searched the app store, previous apps selected and/or installed by the user, apps selected and/or installed by similar users, profile information about a user (e.g. profit/non-profit/personal/enterprise level, etc). Analysis of a wide range of user web presence activity, selections, and the like associated with the app store platform and/or associated with other web presence aspects (e.g. profile information about apps used by web hosting clients of a web hosting service) may benefit targeting visibility enhancement.

The targeting methods and systems of such a platform may have at least two primary objectives (i) recommending apps or services to customers and (ii) monetizing interactions between the users of the platform and the platform. In an example of monetizing interactions, profiles of users may be determined via explicit input from users or implicitly from users activity, web presence elements, and the like. These profiles can be used for monetizing the platform by ensuring that app developers, advertisers, promoters, and the like have visibility to important information derived from these profiles (e.g. a daily count of lawyers who visit the app store). Gaining visibility to a large number of lawyers on a daily basis may be of significant value to a vendor who promotes web presence features for lawyers (e.g. web marketing tools for lawyers). The targeting methods and systems described herein may enable monetizing the user base by providing a way of collecting fees from vendors and the like interested in taking advantage of such targeting.

Targeting may also determine allocations of promotional space in web pages for specific audiences. Passive techniques for determining promotionally valuable information about audiences may include what apps the audience uses, what social group(s) are the audience members of, what is the URL of the audience member, and the like. With directly and indirectly (passively) acquired user profile information the platform may be able to very specifically characterize a user and therefore make changes in the web pages provided to the user. In an example, based on acquired profile information, the platform may determine that a current user is mechanic rather than a consumer. This distinction may be very important because consumers may be interested in local auto mechanic services, whereas an auto mechanic may be interested in automobile parts distributors. With such important distinction, targeting of mechanics can be different than targeting of consumers. In another example, when a small business owner visits the app store website, revenue collection enhancement tools may be made more visible through the targeting techniques described herein.

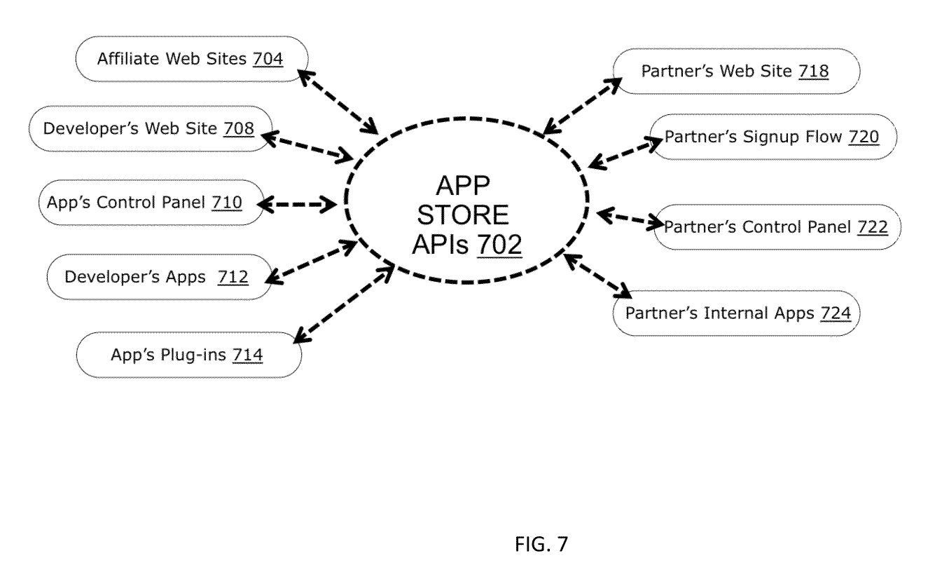

FIG. 7 depicts an exemplary architecture of an active program execution environment of the automated application deployment environment for enabling functioning of the app store of the present disclosure. The architecture illustrates a plurality of application programming interfaces (APIs) 702 and other interfaces that may facilitate collaborative engagement with the app store. The APIs and the interfaces may, among other things, enable communication between the app store and service providers for collaboration with the app store.

The app store APIs may provide a plurality of functionalities associated with the application store, including viewing or updating data of a catalog, such as the catalog of selectable elements presented to the user as discussed herein, requesting contextual data for displaying to the user, requesting or updating partner branding information for displaying in the application store, authenticating users to allow user navigation across services, provisioning of billing functions, provisioning functions, and the like.

The app store APIs 702 may enable communication with an affiliate web site 704 to integrate features and functionalities provided by the affiliate web site into the application store. The features and functionalities may include apps or plugins developed and updated by an affiliate who may be an owner of the website. The services and functionalities as updated on the affiliate website may be retrieved by the app store upon request or automatically after a collaborative engagement begins between them. Similarly, the app store APIs 702 may enable communication with a developer's web site 708. This may motivate the developers to develop applications that are interoperable and readily integrated with the app store or a partner platform. The APIs 702 may also enable the developers to integrate the developed applications within the app store. The APIs 702 may also provide features that may enable the developers to identify the usability of the applications developed by them and help the developers in efficient monetization and distribution of their applications. In an example, the app store APIs 702 may interaction between the app store and a control panel 710 for managing apps installed by or on behalf of a user.

The app store APIs may also enable direct communication with application developers. In this case, the app store may directly communicate with the developers instead of integrating through websites such as in cases of the developers website 708 or the affiliate website 704. For example, the app store may request a particular developer or the developer may volunteer to submit an application 712 to the app store. The APIs may enable integration of the applications 712 with the app store to add to the catalog of services available in the application store. The APIs 702 may also provide tools 714 to enable a provision of the apps as plug-ins to users, developers, partners or affiliates.

The APIs may further enable communication with a partner's web site 718 that may allow better integration of the app store's features with the features and functionalities provided by the partner's web site 718. Thus the app store can be linked to various partner websites 718 in a manner similar to linkage with the affiliate website 704 or the developer website 708. The linkage with the partner website 718 may however provide a broader range of collaboration and/or access to app store-related functionality. The APIs 702 may also enable individual developers to integrate with the partner's web site also for accessing their services in addition to integration with the app store directly. In an example, the APIs 702 may provide tools for implementing a plurality of functions for the partner website or platform that may include but are not limited to developing and deploying of a signup flow 720 on the partner platform, developing and integrating a partner's control panel 722 for an application on the partner platform, and tools for developing, deploying and marketing of internal applications 724 of the partner websites.

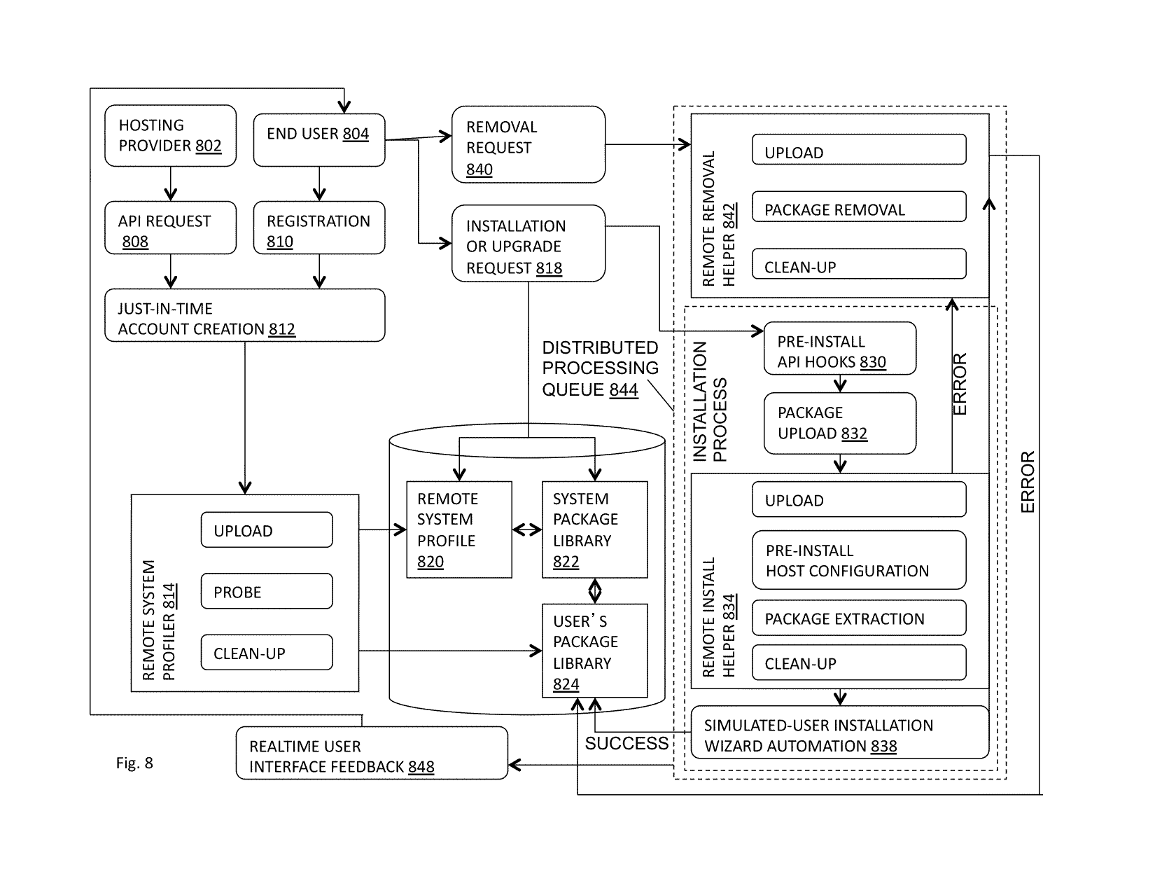

FIG. 8 depicts an exemplary architecture for maintenance of a plurality of web presence programs that may be presented to the users to enhance the web presence of the users. The architecture may be adapted to implement industry standard and best practices for modular encapsulation and loose coupling of components under a model-view-controller (MVC) framework for web presence programs. In an example, the architecture may be developed using well-known technologies available under open source license and/or proprietary licenses depending on the requirements for which the architecture may be developed.

A hosting provider 802 and an end user 804 may issue a plurality of requests to facilitate maintenance of one or more web presence programs that may facilitate web presence of the users. The hosting provider 802 may submit an application programming interface (API) request 808 and the end user 804 may provide registration details 810 such that the selected API may be installed on a target hosting server to facilitate the web presence of the user. On receiving such requests, an account 812 may be created for the end user 802 or for the hosting provider 802. The hosting provider 802 may get an access to the plurality of web presence programs for its own users whereas the end user 804 may get an access to directly install the web presence programs on his/her websites, blogs or any other related web presence locations. On creation of the accounts 812 for the hosting provider 802 or the end user 804, the details may be shared with a remote system profiler 814 that may perform the various functionalities related to web presence program maintenance on a remotely located server as described herein.

The remote system profiler 814 may be a remote helper component that may upload the account details to a remote system profile 820. The uploaded data may include an email id of the hosting provider 802 or the end user 804, name, age, occupation, contact details, mailing address, user identification, and the like to identify profiles of the users. The remote system profiler 814 may further probe the remote system to determine setup, hosting configuration, database capabilities, installed web presence programs, and the like to facilitate automatic web presence maintenance of web presence programs on the remote system. In addition, the remote system profiler 814 may be configured to communicate user data for the corresponding one or more web presence programs to a user's package library 824. The user's package library 824 may be configured to maintain a complete list of user selectable web presence programs and corresponding data that may be required to enable installation of the web presence programs on a target hosting server to enhance the web presence of the users. In addition, the profiler 814 may gather web presence related information from the user's package library 824 to facilitate maintenance of such web presence programs. For example, if a user is interested in installation of a particular web presence program including features similar to features provided by WORDPRESS, the user's package library 824 may be configured to store FTP details, domain name information, control panel information, and the like for the user website so that the architecture may be configured to deploy the particular web presence program automatically on the target hosting server. In addition, either of the hosting provider 802 or the end user 804 may raise additional requests such as a request for an installation or update of the web presence programs 818, a request for removal of the web presence programs 840, and the like for maintenance of the web presence programs.

On receiving the requests from the users, a system package library 822 may be accessed to select the requested web presence program and process the request using a distributed processing queue system 844 as indicated in FIG. 8. The architecture may include a plurality of remote helper components (e.g., remote system profiler 814, remote install helper 834, remote removal helper 842, and the like), a simulated-user installation wizard automation 838, and real-time user interface (UI) feedback 848 from the distributed process queuing system 844 to facilitate maintenance of the web presence program that is represented as a selectable element in a catalog of selectable elements for enabling an online presence of the user.

On receiving a request for remote maintenance of the web presence program, a series of tasks may be generated to be performed in a particular order to satisfy the request for remote maintenance of the web presence program. The series of tasks (e.g., pre-install API hooks 830, package upload 832 and the like) may be distributed to a plurality of networked servers that may communicate over the network to ensure the tasks are performed in the particular order. The tasks may be consumed by the plurality of network servers into a first-in-first-out (FIFO) task processing queue that may include tasks for satisfying a plurality of remote maintenance requests and that may perform FIFO execution of the tasks in the queue. Further, the user may be presented with real-time status of the remote maintenance of web presence programs, and such presentation of the real-time status may be obtained by polling at least a portion of the plurality of networked servers to determine task progress and presenting the task progress in a web presence program maintenance user interface 848. The use of the queuing system may allow the user to navigate away from the web interface 848 without interrupting the automated installation process, resume monitoring of on-going operations at any time, and only consumes load from the interface servers or database when the user is actively monitoring, thus allowing for high scalability.

The architecture may include a remote server that may be configured to install and invoke at least one of the plurality of temporary remote helper API components on the target web presence hosting server in response to a request for web presence maintenance. The plurality of temporary remote helper components may be deployed to the target web presence hosting server on an as-needed and on-demand basis in order to perform one or more web presence maintenance functions. The functions may include but are not limited to determining a suitability of the target server environment for installation of the web presence program, configuring the target server for deployment of the web presence program, maintenance and removal of the presence program that is installed in the target server environment, detecting installed web presence programs and determining compatibility of at least one installed web presence program for inclusion in a remote management scheme that may facilitate management of the web presence programs. Further, the temporary-API components are dynamically configured using a non-conflicting naming scheme so that an unauthorized entity may not be able to intercept the functions of the API components. In addition, the temporary remote helper components may be invoked as a remote API call and after performing the requested maintenance function and returning any data to a requesting node, the helper components may be automatically destructed so as not to clutter file systems or potentially interfere with standard operations.

The remote server may be configured to deploy a temporary remote helper API on the website hosting server for performing a trial installation of the web presence program to facilitate simulated-user installation wizard automation 838. The temporary remote helper API may collect user interaction during the trial installation of the web presence program. Subsequently, elements (e.g., user credentials, configuration values, extant databases, and the like) in an activity record are configured depending on user interaction and hosting server activity during the trial installation. Further, the elements in the activity record and the web presence program configuration data are dynamically accessed to facilitate automated installation of the web presence program. The simulated-user installation wizard automation 838 may enable automatic installation of the web presence program while reducing user interactions that may be required to perform the installation process.

The remote server may be configured to deploy a temporary web presence helper API component on the website hosting server to detect installed web presence programs associated with the website hosting user. Further, suitability of at least one installed web presence program for inclusion in a remote management scheme may be determined. On determination that at least one installed web presence program is suitable for inclusion in the remote management scheme, the website hosting user's web presence program library with references to suitable web presence programs may be updated.

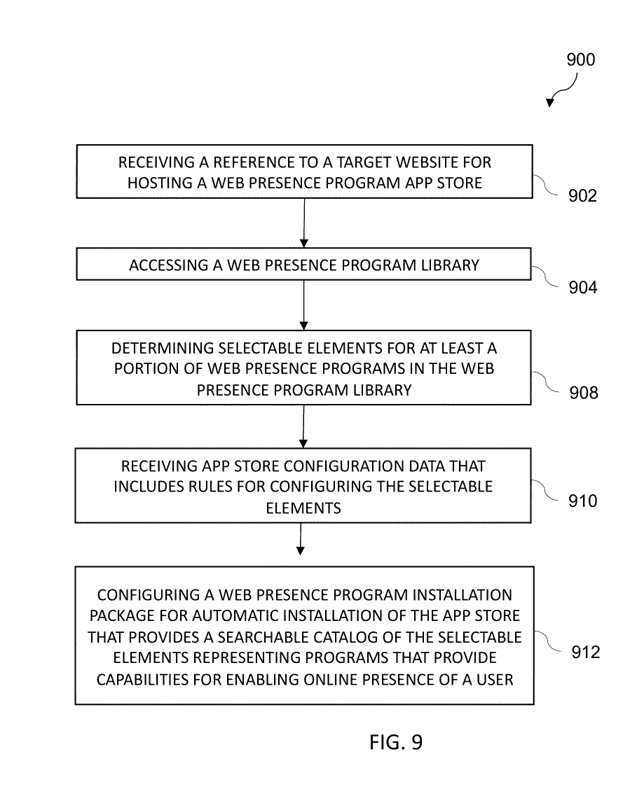

FIG. 9 illustrates a method 900 for automatic configuration and installation of an app store according to some aspects of the present disclosure. The app store may be configured to provide a searchable catalog of selectable elements. The selectable elements may represent a plurality of programs that may provide capabilities for enabling online presence of a customer associated with a website hosting or web presence service platform. The customer may be able to access an app store that is automatically configured at a predetermined website using the method of FIG. 9.

The method 900 may include receiving a reference to a target website for hosting a web presence program app store at 902. In an example, the reference to the target website may include a URL for the target website or any other similar reference. The method 900 may include accessing a web presence program library at 904. In an example, the web presence program library may include a plurality of program elements that may be required for the implementation of the web presence program app store on the target website. In an example, the web presence program library may be accessed in response to receiving the reference to the target website. At 908, the method 900 may further include determining one or more of selectable elements for at least a portion of web presence programs in the web presence program library. In an example, the one or more of the selectable elements may be selected based on a customer preference. In an alternate example, the one or more of the selectable elements may be predetermined based on the target website capabilities. The method 900 may further include receiving an app store configuration data at 910. The app store configuration data may include rules for configuring the one or more selectable elements. The rules for configuring the one or more selectable elements may be based in part on the information associated with the target website. The method 900 may further include configuring a web presence program installation package at 912 for automatically installing the app store that may provide the searchable catalog of the selectable elements. In an example, the app store installation package may include programs necessary for configuring and/or installing web presence programs from the catalog of the searchable selectable program elements to be installed on the target website. The app store installation package may include at least two of the selectable elements, the app store configuration data, the reference to the target website, app store application programmer interfaces (APIs), and a web page location for locating the app store within the target website. In an example, the selectable elements may represent programs that may provide capabilities for enabling online presence of a user or customer, such as a program for setting up an email account for the customer. The method 900 may further include a process for installing the app store on the customer's target website.

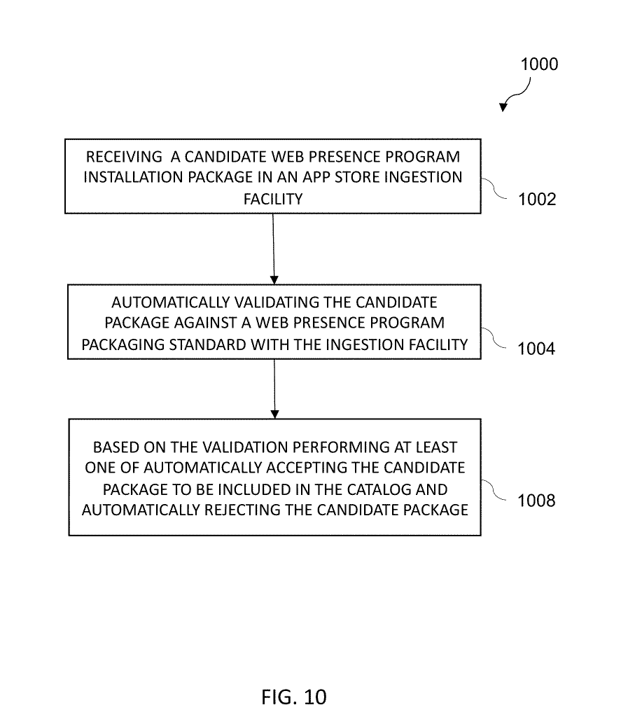

FIG. 10 illustrates a method 1000 of ingesting web presence programs for representation in a searchable catalog of selectable elements. The selectable elements may represent programs that provide capabilities for enabling an online presence of a customer. The selectable elements may for example be presented to a customer of a website hosting or a web presence service platform. The programs in the searchable catalog of the selectable elements may provide the customer with multiple capabilities for enabling the online presence of the customer.

The method 1000 may include, at 1002, receiving a candidate web presence program installation package in an app store ingestion facility. The program installation package may be a package of programs viewable in the searchable catalog of web presence related programs and used to enable installation of web presence programs. The candidate web presence program installation package may be selected based on one or more of a criteria including but not limited to, a recommendation to the customer, requirements of the customer, website or resource limitations of the customer or any other such criteria. In an example, the app store ingestion facility may be implemented as software that may enable automatically performing some of the processes that may be required for enabling a web presence program. For example, for a program for implementing an image gallery on a customer's website, the ingestion facility may provide software support for performing some of the processes related to managing of images, such as adding metadata tags that may identify a source, usage rights and subject matter of the images, adding custom rendering settings, such as black-and-white conversion or any other such processes.

The method 1000 may further include, at 1004, using the ingestion facility for automatically validating the received candidate web presence program installation package against a web presence program packaging standard. The method 1000 may further include, at 1008, performing at least one of automatically accepting the candidate package to be included in the catalog and automatically rejecting the candidate package, based on an outcome of the validation process performed at 1004. For example, the candidate package may be accepted for ingestion in the catalog if it meets the requirements as specified by the packaging standard. The candidate package may be rejected for ingestion in the catalog if it does not meet the requirements as specified by the packaging standard. In an example, the packaging standard may require that the candidate program enables automatic installation of the program and automatic enabling of at least one web presence feature provided by the program.

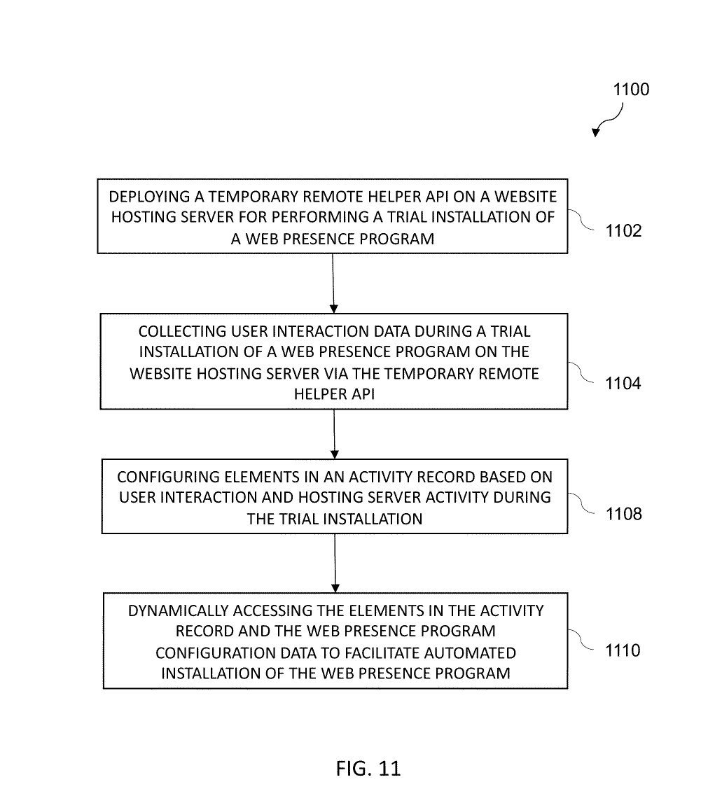

FIG. 11 illustrates a method 1100 for automating a simulated user installation wizard. The method 1100 may include, at 1102, deploying a temporary remote helper application programming interface (API) on a website hosting server for performing a trial installation of a web presence program. The remote helper API may include a collection of programs required for performing the trial installation process. The method 1100 may further include, at 1104, collecting data for user interaction with the website hosting server during the trial installation of the web presence program on the website hosting server. For example, the user may request a specific web presence program from the website hosting server, such as a blogging feature to be deployed on a website. The user interaction data in this case may be related to the user's requested web presence program, In an example, the user interaction data may include data related to the installation of a web presence program on the user's system. The data for the user interaction may be collected via the temporary remote helper API deployed on the website hosting server.

The method 1100 may further include, at 1108, configuring elements in an activity record based on the user interaction data and data about an activity of the hosting server during the trial installation. In an example, the configuring elements may include configuration files that may be required for the installation of web presence program. The data about the activity of the website hosting server may include data about server resources accessed during a particular user interaction with the server, data about server performance characteristics, data about turnaround time for a request served by the server or any other such data. Based on the trial installation process the method 1100 may further include, at 1110, dynamically accessing the elements in the activity record and the web presence program configuration data to facilitate subsequent automated installation of the web presence program. In an example the elements of the activity record may be accessed. In an example, facilitating automated installation of the web presence program may include automatically installing the web presence program on the website hosting server.

In an example, the temporary remote helper API may facilitate collection of user data as well as collection of website hosting server information for use in the trial installation of the web presence program. The data collection by the remote helper API may facilitate reducing user interactions with the website hosting server based on previously collected data. For example, when a user interacts with the website hosting server during a trial installation, the remote helper API may monitor the activities performed by the user while accessing the server and a log of the user activity may be maintained in the activity record. An exemplary user activity may include accessing a blogging feature on the website and at the same time accessing an image uploading feature. The remote helper API may store information related to these activities and also the server data related to the configuration of these two features. If the same user accesses the website hosting server again for accessing blogging on another website or another user accesses the server and performs the same activity, the remote helper API may facilitate making the configuration information for blogging and image uploading features available to the users based on the data in the activity record. This may enable the user to get their requests from the server to be serviced quickly and without requiring repeated interactions with the server.

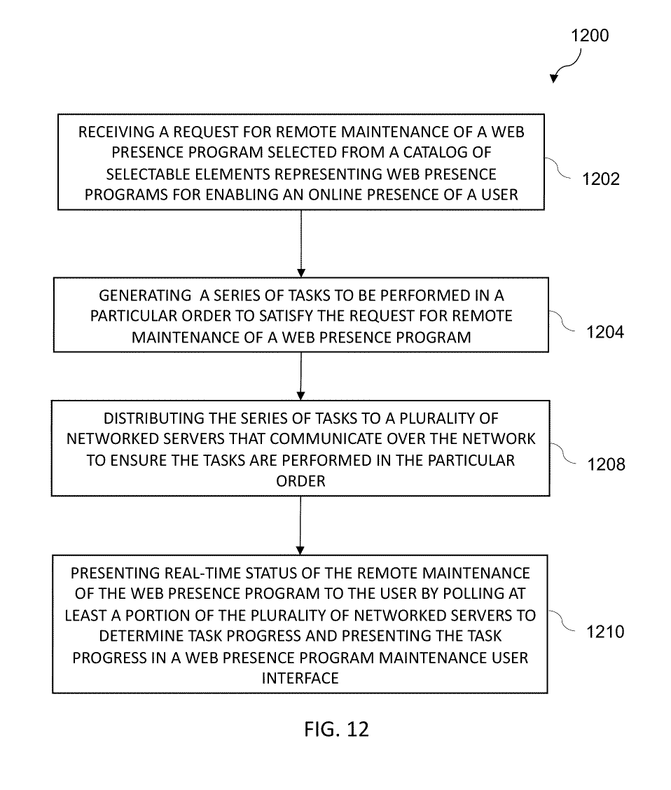

FIG. 12 illustrates a method 1200 for providing a real-time feedback to a user from a distributed web presence program installation process queuing system. At 1202, the method 1200 may include receiving a request for remote maintenance of a web presence program. In an example, remote maintenance of a web presence program may include performing a software update for the web presence program, debugging the web presence program for identification or correction of errors related to the web presence program, and the like. The web presence programs may be selected from a catalog of selectable elements that may represent a plurality of web presence programs that may be required for enabling an online presence of the user. At 1204, the method 1200 may include generating a series of tasks to be performed in a particular order in order to satisfy the request for the remote maintenance of the web presence program. The method 1200 may further include, at 1208, distributing the series of tasks to a plurality of networked servers. The networked servers may include a plurality of servers that may be operating over a communication network to ensure that the tasks required for the remote maintenance of the web presence program are performed in the particular order identified at 1204. Further, in an example, the tasks may be distributed to the plurality of networked servers in order to perform efficient and reliable execution of the tasks. The execution and the performance of the tasks in the order they are required may be monitored. The method 1200 may further include, at 1210, presenting a real-time status of the remote maintenance of the web presence program to the user by polling at least a portion of the plurality of networked servers. The process of polling of the networked servers may include collecting information in real-time about the tasks that may be executed and the tasks that may be pending for execution at each of the plurality of networked servers to determine task progress. The task progress may be presented in a web presence program maintenance user interface to the user to present the real-time status of the remote maintenance of the web presence program. For example, a user interface may include a display showing a listing of tasks and their corresponding servers, along with a numeric representation of the percentage amount of the task executed till a particular point in time. In a similar manner, any other form of user-interface may be used for presenting the task progress.

In an example, the tasks may be consumed by the plurality of networked servers into a task processing queue. The task processing queue may include a plurality of tasks that may be required to be executed for satisfying a plurality of remote maintenance requests. Further, the task maintenance queue may perform a first-in-first-out execution of the tasks in the queue such that a task that is waiting for execution for a longer time in the queue may be executed earlier than a task that may be waiting for execution for a lesser time.

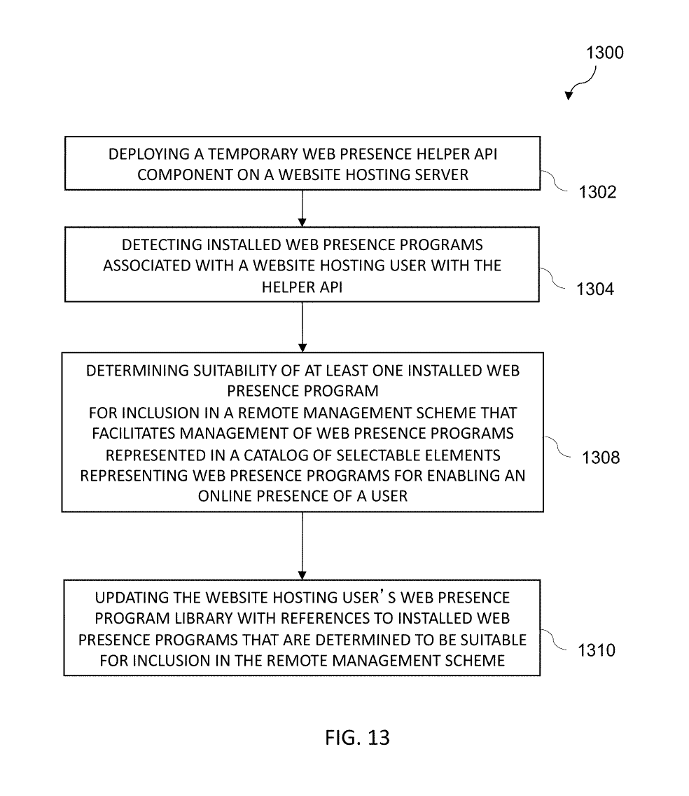

FIG. 13 illustrates a method 1300 for adopting a plurality of pre-existing installations into a simple scripts management scheme. The method 1300 may include, at 1302, deploying a temporary web presence helper API component on a website hosting server. Further, at 1304, the method may include detecting installed web presence programs associated with a website hosting user. In an example, the installed web presence programs may include the web presence programs selected for installation from a catalog of web presence programs by the hosting user. The detection may be performed using the temporary web presence helper API deployed on the website hosting server. In an example, the temporary web presence helper API may include a plurality of programs that may facilitate in identification of programs installed on a website of the user. The method 1300 may further include, at 1308, determining a suitability of at least one installed web presence program for inclusion in a remote management scheme. The remote management scheme may facilitate management of web presence programs represented in a catalog of selectable elements representing web presence programs for enabling an online presence of the website hosting user. In an example, the suitability of the installed web presence program may be based on a user specified criteria. In an alternate example, the suitability of the installed web presence program may be based on a billing or monetary criteria. For example, a program associated with a premium service provided by the website hosting server may be associated with a high cost. Such a program may not be accessible to the user based on a payment status of the user. Thus, such a program may not be included in a list of programs to be managed by the remote management scheme for the user. The method 1300 may further include, at 1310, updating the website hosting user's web presence program library with references to installed web presence programs that may be determined to be suitable for inclusion in the remote management scheme. In an example, updating the website hosting user's web presence program library may include maintaining a record of an updated list of web presence programs included in the remote management scheme. In an alternate example, updating the website hosting user's web presence program library may include displaying an updated list of web presence programs included in the remote management scheme.

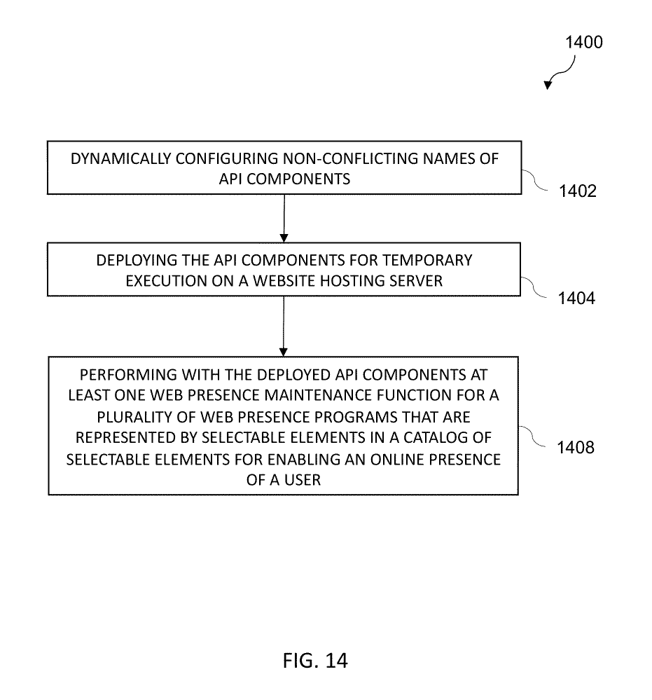

FIG. 14 illustrates a method 1400 for simultaneously installing a plurality of web presence programs into a single hosted environment to enhance a user's web presence. At 1402, the method may include dynamically configuring non-conflicting names for a plurality of components of an application programming interface (API). In an example, the API components may include a plurality of programs for enabling access to a plurality of web presence programs for installation in a hosted website environment. In an example, dynamic configuration of non-conflicting names for these API components may be done by sequentially numbering the API components to assign a unique number for each API component name. This may enable simultaneously installing a plurality of similar components that may in an example be from multiple computing architectures or multiple computing vendors, on the same hosted website. For example, the API components may be related to configuring of multiple email accounts for a user. The dynamic configuration of non-conflicting names may include selecting non-conflicting names for each of these email account configuration files. The method 1400 may further include, at 1404, deploying the API components for temporary execution on a website hosting server. Further, at 1408, at least one web presence maintenance function may be performed with the deployed API components. The at least one maintenance function may be related to a plurality of web presence programs that may be represented by selectable elements in a catalog of selectable elements for enabling an online presence of a user. In an example, the at least one web presence maintenance function may be selected from a list of functions containing installation, configuration, upgrade, and uninstallation functions. In an example the deployed API components may be capable of self-destructing upon completion of the at least one web presence maintenance function.

The present method and system of automated application deployment described above may be implemented with the use of software that may power the most popular app stores and marketplaces for various applications, web presence features, add-ins, upgrades, and the like. This may provide an opportunity to websites to make relevant apps and services for use in the app stores of the automated application platform and earn money by development and selling of the apps or such as collaborative engagement with a service provider providing various services through the platform. The app store technology may provide a turnkey solution that may create an add-on marketplace around any website or application wherein the app store may provide or update relevant applications or web presence services as available in the app stores to the consumers automatically. The app stores may be implemented through a proprietary technology capable of installing, updating, uninstalling, or migrating one or more catalog web apps simultaneously to a variety of the most popular hosted environments.

The automatic application installation and deployment methods and systems may include a capability to recommend apps, services, plugins, or themes to consumers. This may be done by retrieving contextual information of consumers from social networks or social aware networks to which the consumers may be associated. In another example, the relevant contextual information may be obtained from various other sources such as relevant industry, job duties, and the like. Based on the contextual information about the consumers, the automatic application installation and deployment methods and systems may recommend apps, services, plugins, or themes that may be best suitable or matching to the context and interest of the consumers as understood from the obtained contextual information. The consumers may search the applications or services by browsing the searchable catalog of the app stores and also read brief descriptions of the apps and services, and therefore may identify the apps or services based on benefits and solutions rather than based on features and categories alone. In this way, the automatic application platform facilitates the consumers to find apps and services of their benefits and interest.

The automatic application installation and deployment methods and systems may be based on a technology framework implemented on a model-view-controller architecture. The framework may enable separation of the model, view and controller components of the system to enable flexible, simpler and efficient development and deployment of applications and services. Applications may be developed independently from an environment where they may be installed and executed, thus offering efficient separation of the model, view and controller components. Further, the technology framework may provide easier application installation by doing away with the requirements of application packaging and related requirements.

In addition to providing the apps and services, the methods and systems of automated application deployment described herein may support several offerings such as catalog listing, searching, comparison, customer ratings, reviews, popularity, and the like. The methods and systems of automated application deployment may also support installation of hundreds or thousands or several themes and plug-ins for apps, such as WORDPRESS. In an example, the methods and systems of automated application deployment may contribute to the development of a theme marketplace. For example, several theme developers may make relevant supply relevant themes to the service provider who deploys the methods and systems described herein and thereby earn monetize through it. Similarly, in an example, the methods and systems of automated application deployment may contribute to the development of a plugin marketplace by offering plugins for web based services, applications and features within or further related to the applications.

The users or consumers may interact with the web presence remote maintenance system to search the apps and services through the searchable catalog of the app stores. The app stores may also provide interactive demos that may allow the users to select various combinations of services and apps. For example, a user may choose an application, such as WORDPRESS from the searchable catalog of the app store. The user may then browse through various available themes that may match the selected applications (WORDPRESS). The user may also view demos as to how the combination of the selected application and the theme will look like.

The users may be provided with special packages of the apps, services, themes and plugins with specially established pricing. For example, different packages including a combination of more than one theme, plugin, and the like for a given app such as WORDPRESS or for a family of apps such as bogging apps may be provided at discounted prices to the users. In some cases, special and simplified one-time fee or payment-based packages may be provided such that the users may pay a nominal amount at one time and then use the facility of the app stores for defined period of time such as for a month or a year without any need to pay again at regular intervals. The methods and systems of automated application deployment as described herein may employ a billing module for paid themes or packages. The billing module may be configured to set pricing for various apps and services, accept payments, and share revenue for various products or apps or services to collaboratively linked partners to bundle or sell along-side native services or apps or products. For example, revenue or fee may be shared among web presence remote maintenance system operator, apps developer, affiliates, app store website owners, and the like.

In an example, the various themes available in the app stores may be sold during an app install process by the web presence remote maintenance system during installation of WORDPRESS app or any other app.

The automated application deployment system and method as discussed herein may be compatible with a plurality of web hosting control panels that may provide tools for managing resources of a server for a web hosting service provider. The control panels may include but are not limited to available website hosting control panels such as cPanel, VDeck, interworx, Plesk, Verio, Websitepanel, encompass, or any other control panel. The methods and systems described herein may include a customer control panel that may be bundled with the automatic application installation and deployment system. The customer control panel of the web presence remote maintenance system may be configured to perform multiple functions for a customer of the web presence remote maintenance system such as managing the installation or uninstallation of applications and performing version upgrades for applications already installed by the customer.

The web presence remote maintenance methods and systems described herein may provide a number of features for leveraging existing web based resources, such as communities of designers/developers who prepare applications, plugins, themes, and the like for web sites, for addition to the catalog of products or services or apps of the app store. The applications for the app store may be acquired through an application ingestion process to authenticate applications for addition to the catalog.

The web presence remote maintenance methods and systems may provide a publishing feature that may allow users of the web presence remote maintenance system to post content or applications to a third party application from any supported application of the web presence remote maintenance system. The web presence remote maintenance methods and systems may further provide a social sharing feature that may enable applications from third party sources, such as from individual developers, to support sharing social information across multiple social media gateways such as Myspace, Linkedin, Facebook and the like. The web presence remote maintenance methods and systems may further provide a ‘glue’ feature that may facilitate passing data among installed applications to provide a consistent user experience. The web presence remote maintenance methods and systems may further provide an engagement feature that may provide a capability to enable or disable certain features of applications and plugins based on a centralized business logic (CBL) before or after the installation of such applications and plugins. The CBL may be configured separately for each user account of the automatic application installation system, and may be used to provide differentiated services to users of the system. The web presence remote maintenance methods and systems may further provide customizable alerts for the users of the system. The alerts may be sent to the users based on a variety of criteria that may include user specified alert thresholds and the like without limitations.

The web presence remote maintenance methods and systems may be configured to provide an activity stream feature that may allow a user to publish user activities from supporting applications to the user's activity stream providing a useful historical view of a user activity. The web presence remote maintenance methods and systems may further provide a shortcuts feature that may be similar to a desktop shortcuts available on computer systems and that may make deep links and other applications or user-specific shortcuts available to the user's control panel. The web presence remote maintenance methods and systems may further enable a tracking feature that may allow passing statistical data from supporting applications so that it may be visualized in an integrated dashboard such as the user control panel of the web presence remote maintenance system. The web presence remote maintenance methods and systems may further support a stats feature that may facilitate managing an app store and provisioning of admin capabilities for managing the web presence remote maintenance system. The admin capabilities may include query and display capabilities per application and/or seller. The query and display capabilities may also relate to partner website related statistical data such as data about top selling applications and plugins, ratings data, ranking data, sources, revenue information, revenue share, and conversion data for each partner website, and the like. Query statistics may be provided to a user sorted by product or by date.

The web presence remote maintenance methods and systems may provide features and capabilities related to management of data for affiliate websites. The features may offer and manage a turnkey affiliate program that may incorporate instant application install features. This may enable affiliates to generate more revenue for their products and applications. Further, the web presence remote maintenance methods and systems may offer advertising related features to users that may enable the users to leverage marketing features for their products. The features may include bidding, paying, managing and viewing preferred sponsorship locations on a web page for ad placement, and ad placement related to key areas within a marketplace. Additionally, the web presence remote maintenance methods and systems may allow users to configure and display upsell offers for their products and applications. For example, a user of a content management solution on a web hosting platform may be provided offers for content management solution installations from vendors or providers of content management services. This may enable revenue generation opportunities for the vendors or service providers. Alternatively, the user may also be offered complementary services, such as email account management and set-up services, based on user's configuration data and preferences related to an already installed content management solution.

The web presence remote maintenance systems and methods may also provide seamless login capabilities for web-based services, and token-based authentication directly from the app store, a partner-hosted control panel, or an installed app. The web presence remote maintenance systems and methods may further provide hosting services for executing host and control panel-supported file and system operations. The web presence remote maintenance systems and methods may further offer an instant domain name system (DNS) feature that may enable offering basic DNS services to customers that may allow assigning cloud application specific domains to the customers. Additionally, the web presence remote maintenance methods and systems may enable instant installation of applications on a supporting web host for the applications (such as by a one-click installation process). For this installation process, the process of user account creation may be performed in the background, allowing users to seamlessly sign-up for the account and install applications. Similarly, the web presence remote maintenance systems and methods may offer a seamless registration process for the users to register for accessing and deploying various applications and web services through the web presence remote maintenance systems and methods. The registration process may be made token-based such that a user may interface directly with the app store, a partner-hosted control panel, or an installed application for accessing web based applications and services.

The web presence remote maintenance methods and systems may also offer a billing sub-system or module that may enable app store website owners to set pricing, accept payment and share revenue for various products to bundle or sell along-side their native services.

The web presence remote maintenance methods and systems may serve as a marketplace for various applications and services. The web presence remote maintenance systems and methods may provide an app store catalog for each website-specific use of the app store. The app store may be customizable according to each website separately. The customizable features may include features related to branding, pricing, integration details, preferred placements, sort order, apps offered, and the like.

The methods and systems of automated application deployment described herein may support various business model features. For example, an ad space may be sold within an app store, within a catalog of apps, such as on install status screen and the like. In an example, an internal boarding tool may be provided to facilitate submission of new apps, plugins, and themes, and the like for environments that may have both a development store and an app store. For example, AMAZON may have an app store and may leverage the internal boarding tool to add apps from various sellers of AMAZON who develop or otherwise make apps, plugins, themes, and the like available to AMAZON. These apps or plugins or themes made available by the sellers of the AMAZON may be suitably used by the app store of the present automated application deployment methods and systems. In an example, WORDPRESS ‘power bundles’ may be offered through the searchable apps catalog. Plugin developers may be sold hosting services to allow them to have websites that may provide a home base for offering various plugin related services, such as technical support, marketing, and the like.

In an example, the automated application deployment described herein may install flow upsells. For example, during an automated installation process of an app, various upsells for premium or other pay services or features may be presented. The upselling can be done based on contextual relevance to installed apps so as to increase probability of being purchased by a user during installation of the apps. There may be a high probability that a user may be ready to accept a modest costing upsell at install time that may be contextually relevant. The same user however if offered the same upsell later may simply ignore it if the installed app is functioning considering the upsell as a mere “as advertised” product without the upsell features. In an example, free features may be sold to users in the form of freemiums apps with or without revenue sharing model. In an example, the web presence remote maintenance system and method may enable launching of an API and developer central that may enable developers to leverage advantages of the script based system development, deployment and distribution of applications.

The method and systems described herein may support self service development by using a self service developer on boarding tool. The tool may provide a capability to enhance the way apps developers test, qualify, and upload newly developed apps and/or plugins to the app store. The developers may also be facilitated for automated apps submission to the app stores of the automated deployment methods and systems. The method and systems described herein may also support self-service affiliate on boarding that may allow new affiliates to join in offering apps to the app store. This may also allow an affiliate to automatically on-board a block of available apps, plugins, themes or the like. The methods and systems described herein may be adapted to facilitate generation of monetary opportunities while collaborating with advertisers. The advertisers including but not limited to application developers, software vendors, service providers and the like may be provided an option to submit an advertisement for their respective products or services such that the submitted advertisements may be displayed to the consumers and more specifically to the targeted consumers using well known targeted advertisement techniques including the techniques as described herein.

The systems may be configured to facilitate banner advertising to generate revenue from the advertisers. The systems may display advertisements of products and/or services of respective advertisers in the form of the banners such as on the currently viewed catalog of the script based applications such that the consumer may select a particular banner ad to further explore the products and/or services as advertised therein. On selection of a particular banner ad, the advertiser's account may be deducted for a predetermined amount of money to establish a business model for promoting the advertisements and generating the revenue thereof. In an example, the banner ads may be displayed to the consumer when the consumer wishes to install a particular script based feature on his/her website. The consumer may visit the catalog providing list of time management features (e.g., attendance tracking for employees) for installation of such features on the website.

The systems may be configured to display a banner ad to the consumer such that the banner ad may provide a direct link to a web page indicating details (e.g., installation) of a script based package for time management features that may be delivered by a respective advertiser. As a result, the advertiser may get an opportunity to directly sell the respective products and/or services to the prospective consumers through the banner ad and the systems may facilitate generating revenue for service providers from the advertisers. In another example, the systems may be configured to display the advertisements to the consumer when the consumer updates an existing script based package on his/her website. In this scenario, the systems may retrieve details of the existing script based package and accordingly may deliver an advertisement to the consumer related to the existing products and/or services available with the consumer. In an example, the systems may be configured to employ behavioral tracking of the consumer and accordingly display the ads to the consumer. The systems may be configured to analyze the existing web presence and other related information and display products and/or services in the form of banner ads that may aid the consumer in increasing web presence of the consumer.

The methods and systems described herein may facilitate sponsorships of applications or even blocks of application on keywords, category, tag, use, section, installation, updating, RSS feeds, Blog, How-to, and the like. In an example, e-commerce based companies (e.g., PAYPAL and other companies) may sponsor a plurality of e-commerce related applications such that a consumer may use the e-commerce related applications for buying and/or selling products using platforms sponsored by the e-commerce based companies. In this scenario, the systems may be adapted to receive sponsorship fee from the sponsored companies and the sponsorships may be provided while providing a “sponsor” headline or image in the catalog providing the list of script based applications for the consumer. Further, the systems may be adapted to generate a list of a plurality of sponsorships as a search result when the consumer searches for a particular script based application on the catalog. The list of sponsors further may be displayed in the form of hierarchy depending on the various factors such as the consumer interest, geographic location, consumer identity, allocated budget, freeware, shareware, ratings, comments and the like.

The systems used herein may further be configured to facilitate recommendation of the script based applications on receiving a recommendation fee from the respective advertiser such as the application developers, software vendors, service providers and the like to display the recommended applications to the consumer. Similarly, the systems may be configured to facilitate display of related script based applications for the consumer and the respective advertisers of the related script based applications may submit a fee to enable a revenue generation model.

The systems may be configured to facilitate a plurality of revenue generation techniques to enable the advertisers to deliver the advertisements to the targeted consumers. In an example, the systems may analyze performance of web presence related activities of the consumer and may suggest future steps that may be of use for the consumer to increase the web presence. While suggesting the future steps, the systems may provide advertisements of related product and/or services to the consumer for increasing web presence of the consumer. In return, the advertisers may share a fee for displaying their respective advertisements. For example, the systems may suggest to the consumer various trends in efficiently managing web site, enhancing security and productivity and the like for a hosted website and the various script based applications thereof. Accordingly, various products from the advertisers may be provided to the consumer resulting into an easier access of market for the advertisers and enabling a robust revenue generation model.

The methods and systems described herein may allow the advertisers to publish advertorials, paid surveys, paid reviews, and the other information corresponding to the products and/or services (e.g. script based applications) using the app store. The advertisers may submit an initial fee for submission of the paid advertorial to reach out potential customers. In an example, a cloud computing based company may publish an advertorial indicating advantages of the cloud computing architecture for delivering the services to the consumer. In addition, the cloud based company may further provide details of the products and/or services that may be offered by the company such that the consumer may get an access to these products and/or services for improving productivity. The systems may be adapted to deliver such information (which is available in the form of advertorials, paid news, reviews and the like) to the plurality of consumers and more specifically to targeted consumers. The advertisers may pay for creation and delivery of paid news to the targeted consumers to enhance business and marketing campaigns for the respective script based applications. In another example, the systems may be adapted to charge from consumers to view reviews of a particular application and the reviews may be provided by technical experts of a domain for which the script based application may have been developed.

The advertisers may further pay to create an awareness campaign for a special feature of a particular script based application that may encourage the consumer to purchase or access the application for at least a trail version. Otherwise, performance of a particular application that may be available from a plurality of advertisers may be compared and the compared results either may be published on a website or delivered to a plurality of consumers such that the consumers may receive a high quality application and respective advertisers. The advertisers may be able to enhance brand identity for delivering high quality applications to the consumers.

The systems may further be configured to generate revenues depending on placement of the advertisement on a display screen, format of the advertisement, category and other related features associated with the script based applications. In an example, a first advertiser may need to pay an amount different from an amount paid by a second advertiser when the first advertiser chooses to display the advertisement on the top of all advertisements for the specific script based application. The systems may be configured to categorize the advertisements of the script based application so that difference consumers from different categories may be able to access the advertisements. For example, an advertisement of the script based application in a newly featured category may allow a recently developed application to be seen by a plurality of consumers accessing this category. Other categories may include highest rated, top ten, highest commented, and the like for an easy access of the script based applications that may be available from the advertisers. The systems may enable the advertisers to select an option of a particular format for displaying the advertisements. The format may include a text format, an audio format, a video format, a multimedia format and the like. Different advertising rates may be established to generate revenue from the advertisers. For example, an advertisement from a particular advertiser may be shown with enhanced displays (e.g., bold text, larger size and the like) so that this advertisement may be easily identified by the consumer. The systems may establish different charging rates for display of such advertisements with different placement and different formats.

The system as described herein may be configured to store statistical data regarding various products and/or services, consumers, advertisers, recent trends related to installation of script based applications, performance statistics of the applications, marketing and selling trends of the script based applications and other related data that may be used to promote business using the system. In an example, advertisers may purchase the statistical data depending on their business requirements so as to reach a plurality of consumers to increase business opportunities. This may help them conduct primary and secondary market research using the statistical data. In another example, consumers may purchase the statistical data and use it for conducting further primary or secondary marketing research and data analysis so that the consumers may be able to purchase the best applications for a given budget. Other third parties may also purchase the statistical data to provide ratings for the advertisers or the respective products and/or services.

The system may be configured to generate revenue by providing an email blast feature to advertisers so as to enable the advertisers to deliver information regarding the respective products and/or services to a relatively large number of consumers through email. The system may be configured to receive an authorization from consumers regarding receiving information about the products and/or services or any other information. After authorization from the consumers, emails from the advertisers may be ensured to not automatically go to spam folders of the consumers and chances of accessing of these emails by the respective consumers may get increased. As a result, the email blast feature as provided by the system may enable the advertisers to reach a relatively large number of consumers and more specifically to targeted consumers.

The advertisers may be provided an option to present their respective script based applications using an app store premium placement feature. The system described herein may be adapted to enable placement of the advertisers' script based applications as premium applications so that the particular applications may be displayed to the consumers for a direct access. Similarly, the system may enable a control panel premium placement feature to the advertisers so that the respective advertisements of the advertisers may be displayed on a control panel of a website in a manner that the consumers may directly access the premium advertisements. For example, if a consumer is accessing a chat feature on a control panel, the system may be configured to display a premium advertisement of applications related to the chat feature on the control panel. The system may further be adapted to provide a feed sponsorship feature to the advertisers so that the advertisers may deliver information regarding the respective products and/or services to the plurality of consumers through feeds such as RSS feeds.

The system may be adapted to enable integration of different control panels for easy use by the consumers. In an example, the system may enable integration of a web hosting environment and a web hosting control panel to provide a single integrated control panel to the consumers. Different hosting control panels such as cPanel, Plesk, Parallels Automation, DirectAdmin and like may be integrated to facilitate access of features that may be provided by these different hosting control panels using the integrated control panel. The system may generate revenue from various vendors of these control panels so that the advertisers or the consumers may access the features of the control panels from any or a combination of these control panels using the integrated control panel. The system may further be configured to generate revenue by enabling development of plugins that may be supported by the system. The plugins may enable provisioning of new features or interaction of other systems or platforms with the system such that the advertisers or consumers may be able to access a relatively higher number of scripts based applications. In addition, various customization capabilities may be enabled in the system. In an example, an advertiser may be provided an option to customize display of advertisements to the consumers depending on constraints such as a type of product and/or service, targeted budget and the like. Such customization capabilities of the system may provide flexibility to the advertisers so that advertisers may efficiently manage the targeted consumers within the allocated budget. In additions, the customization capabilities may enable consumers to customize a particular package depending on the respective requirements.

The system may be adapted to make available installation of sponsored products and/or services to the consumers. Various advertisers may submit a sponsorship fee to sponsor their respective products and/or services to a selected segment of or all consumers. In an example, the system may be configured to select targeted consumers for a particular advertiser such that the particular advertiser may promote respective products and/or services to these selected consumers. In addition, the advertiser may be provided an option to generate paid reviews or opinions regarding the products and/or services so that the consumers may be educated more professionally regarding the script based applications that may be sold by the advertiser. The system may allow professionals, technology leaders, third parties, engineers, consumers and the like to establish reviews for the script based applications that may be offered by the advertiser. Also, the system may enable individuals, consumers and others to submit comments, testimonials and the like for the script based applications.

The system may be adapted to provide a promotional feature to the advertisers such that the advertisers may select a particular feature to generate promotional tweets or posts or similar messages on social media networking websites to create awareness for the respective script based applications. For example, if an advertiser wants to create an awareness on his cloud-based script applications, the system may provide features to the advertiser so that the advertiser may be able to publish information associated with the script based applications on a plurality of social networking websites, related developer community website, industry leading news websites and the like depending on a budget allocated by the advertiser. Otherwise, the system may enable the advertiser to deliver the information associated with the respective products and/or services through a targeted mailing list that may include email addresses of the potential consumers for the advertiser.

The system may be adapted to deliver a bundle of services and/or products from a plurality of different advertisers to the consumers in the form of a complete package of services. That is to say, the system may be adapted to provide web domain managing service to the consumers. To deliver these services, the system may select one script based application from a first advertiser and another script based application from a second advertiser to deliver these services in the form of a bundle of services so that the end consumers may not require selection or integration of services from the different advertisers. The system may further be adapted to provide an option to the advertisers to sponsor an event that may be related to the products and/or services offered by the advertisers. With such a sponsorship, the advertiser may be able to build his brand for the respective services and create awareness among the targeted consumers. Further, a booth space may be shared among two different advertisers in order to reduce the cost of the advertising budget. For example, the first advertiser may provide security based applications and the second advertiser may offer data analytics related applications for the website. The platform may be adapted to provide the shared booth space among the first and the second advertisers so that both of these advertisers may market collectively to provide services as a package to consumers in a relatively cost effective manner.

The system may be adapted to integrate with other partner websites such that the advertisers or consumers may be able to access features of the partner websites using a single app store platform. Further, the system may be adapted to deliver a plurality of applications that may enable automation of an entire marketing workflow for the advertisers or consumers. The system may enable the advertisers to perform all the complex and time-consuming tasks of lead management that may include lead scoring, lead nurturing and customer relationship management (CRM) integration and various other management tasks. The system may facilitate the advertisers to optimize various marketing processes ranging from campaign planning to execution and analysis of a particular marketing campaign.

The automatic application installation and deployment methods and systems described herein may provide several benefits and functionalities to the users. For example, the automatic application installation and deployment methods and systems may provide app or plugin or theme catalogs. Such catalogs may be searchable and may help a user to browse and find the best available solutions in terms of app or plugin or theme for the user. For example, the user may be displayed various kinds of apps icons for allowing the user to select the required app. The catalogs may help the user to understand how each presented app or plugin or theme may help them. For example, based on requirements, the user can compare the presented app or plugin or theme before making the selection among the presented apps or plugins or themes. The catalog may also help answer questions or concerns pertaining to any of the presented apps or plugins or themes. For example, each of the presented apps or plugins or themes may be associated with anecdotes or elaborative descriptions, pictures, videos or demos explaining the apps or plugins or themes to a greater detail helping the user to understand about the respective apps, plugins and themes. The catalog may also help the user in making a selection decision. For example, each of the presented apps or plugins or themes may be associated with reviews, ratings, comparisons, or recommendations. Based on these reviews, ratings, comparisons, or recommendations, the catalogs may provide the user a clear and simple way to select the solutions, in terms of choosing an app or plugin or theme, that interests them the most.

The automatic application installation and deployment methods and systems described herein may support a e-commerce functionality. The e-commerce functionality may include a shopping cart feature and various other features. The shopping cart feature may enable a user to temporarily save selected solutions, for example, selected apps or plugins or themes, so as to review them later and make a final selection among the selected solutions at a later time during deciding about purchasing or not purchasing any or all of them. The e-commerce functionality or the shopping cart feature may further enable the user to make payment for the selected solutions after purchase is decided or completed. In an example, the user can select multiple solutions from same or different vendors and make a single payment to purchase for all the selected or purchased solutions. The shopping cart feature may enable the user to purchase ‘gift cards’ and redeem ‘store credit’ for faster and easier transactions. The shopping cart feature may also enable the user to track previous purchases and send receipts and reminders. The shopping cart feature may simplify payment options and methods for users form different geographies internationally. For example, the shopping cart feature may support multiple currencies, and support a variety of payment methods in order to help international users from different geographies to make payments and complete other transactions easily and quickly in a user friendly manner. The shopping cart feature may maintain and store historical information about a user's purchases and identify the nature and behavior of the user based on the historical information and accordingly may send recommendations and reminders for potential new purchases that may interest the user in near future. The shopping cart feature may also suggest the user other solutions that may work well with the solutions already purchased or in the cart.

The automatic application installation and deployment methods and systems described herein may provide a setup wizard. The setup wizard may help in validating system components and other relevant information that are required by a user's system for using a particular solution such as an app or a plugin or a theme and the like. The setup wizard may ensure that necessary software and hardware installation dependencies are met for the solution to work effectively. For example, once the user has selected a solution, the setup wizard may guide the user to obtain any additional items or services needed to complete the solution that is to install the solution successfully. The setup wizard may simplify configuration of the available solutions by auto-installing them using the most popular and most user friendly options. The setup wizard may orient the user to the best uses of the solutions, such as apps and guide about where to find supporting resources and best practices for the respective solutions. After installation, the setup wizard may suggest logical next steps to the user to use the installed solution (for example the installed app) successfully.

The automatic application installation and deployment methods and systems described herein may support an administration panel. The administration panel may be configured to perform tracking functions for various applications of a user of the script-based system. For example, the administration panel may be configured to track products or applications acquired or installed by the user from the catalog of selectable applications available from the app store. The administration panel may also track sources of these applications, that is to say locations where these applications may be placed or by which developer the applications may be provided, on the web. The administration panel may provide shortcuts for effective utilization of the user's solutions, such as providing a one-click installation procedure for a solution. The administration panel may also enable different applications or product installations to interoperate with each other. In an example, the administration panel may be configured to provide recommendations to the user about additional applications that may be of interest or use for the user. The administration panel may also provide recommendations to the user about the effective usage of user's installed applications. For example, the administration panel may suggest to the user about the best hardware configuration or tools required for deployment or execution of an application. In an example, the administration panel may be configured to provide assistance in managing purchase related information of non-registered users of the script based system or users who may not have any purchased hosting services or domains. In an example, the administration panel may provide a unified login feature to the user for accessing multiple solutions or applications.

The web presence remote maintenance systems and methods described herein may offer multiple benefits and functionalities to developers of applications and web services offered through the automatic installation system. The benefits of using the web presence remote maintenance systems and methods for application installation may include ease of addition of products and services to the catalog of products and services, simpler management of pricing and presentation of applications to the users, simplified on-going distribution of the applications through easier version upgrade and code change processes or any other such benefits. The web presence remote maintenance systems may be able to offer these benefits through the use of application program interfaces (APIs) and programming tools that may enable the various applications to interoperate and integrate with platforms of partner websites of the scrip-based systems. The APIs and programming tools may be used by developers, affiliates and users for development and automatic deployment of applications for the app store. The developers may be able to develop robust and compatible applications using these APIs and programming tools that may be usable across a wide variety of platforms. This may help the developers to monetize their products and services. Additionally, the developers may be able to use customer feedback and statistical analysis related features provided by the web presence remote maintenance system to understand popularity and usage statistics of their applications. This feature may also help the users or customers of the system to specify their requirements and avail the benefit of customized applications based on their feedback. The web presence remote maintenance system may also provide tools and links for enabling instant installation of applications that may be located anywhere on the web.

The web presence remote maintenance systems and methods may offer multiple benefits and functionalities to partner web sites that may be collaboratively associated with the automatic installation system for provision and utilization of applications through the system. The web presence remote maintenance systems and methods described herein may allow partner systems to self-deploy a private-label app store under their own brand and further provide them with tools to manage branding and contents of their app store catalog. The private label app store may be a collection of applications provided by the partner, under their own name and brand. The web presence remote maintenance systems and methods may further help the partners in promoting their brand by providing marketing tools that may provide simple features to market catalog contents in domains where the partners may have a strong presence. The web presence remote maintenance systems and methods may also provide APIs and tools for more deeply integrating the app store features into a partner's web platform, and may further enable developers to integrate with partner's services. These tools may also enable provision of better integration of features such as billing services, affiliate tracking services and reporting with the partner platform. Additionally, these tools may support enhanced system security features that may support upgrading of scripts to support the latest release of security software.

While only a few embodiments of the present invention have been shown and described, it will be obvious to those skilled in the art that many changes and modifications may be made thereunto without departing from the spirit and scope of the present invention as described in the following claims. All patent applications and patents, both foreign and domestic, and all other publications referenced herein are incorporated herein in their entireties to the full extent permitted by law.

The methods and systems described herein may be deployed in part or in whole through a machine that executes computer software, program codes, and/or instructions on a processor. The present invention may be implemented as a method on the machine, as a system or apparatus as part of or in relation to the machine, or as a computer program product embodied in a computer readable medium executing on one or more of the machines. In embodiments, the processor may be part of a server, cloud server, client, network infrastructure, mobile computing platform, stationary computing platform, or other computing platform. A processor may be any kind of computational or processing device capable of executing program instructions, codes, binary instructions and the like. The processor may be or may include a signal processor, digital processor, embedded processor, microprocessor or any variant such as a co-processor (math co-processor, graphic co-processor, communication co-processor and the like) and the like that may directly or indirectly facilitate execution of program code or program instructions stored thereon. In addition, the processor may enable execution of multiple programs, threads, and codes. The threads may be executed simultaneously to enhance the performance of the processor and to facilitate simultaneous operations of the application. By way of implementation, methods, program codes, program instructions and the like described herein may be implemented in one or more thread. The thread may spawn other threads that may have assigned priorities associated with them; the processor may execute these threads based on priority or any other order based on instructions provided in the program code. The processor, or any machine utilizing one, may include memory that stores methods, codes, instructions and programs as described herein and elsewhere. The processor may access a storage medium through an interface that may store methods, codes, and instructions as described herein and elsewhere. The storage medium associated with the processor for storing methods, programs, codes, program instructions or other type of instructions capable of being executed by the computing or processing device may include but may not be limited to one or more of a CD-ROM, DVD, memory, hard disk, flash drive, RAM, ROM, cache and the like.

A processor may include one or more cores that may enhance speed and performance of a multiprocessor. In embodiments, the process may be a dual core processor, quad core processors, other chip-level multiprocessor and the like that combine two or more independent cores (called a die).

The methods and systems described herein may be deployed in part or in whole through a machine that executes computer software on a server, client, firewall, gateway, hub, router, or other such computer and/or networking hardware. The software program may be associated with a server that may include a file server, print server, domain server, internet server, intranet server, cloud server, and other variants such as secondary server, host server, distributed server and the like. The server may include one or more of memories, processors, computer readable media, storage media, ports (physical and virtual), communication devices, and interfaces capable of accessing other servers, clients, machines, and devices through a wired or a wireless medium, and the like. The methods, programs, or codes as described herein and elsewhere may be executed by the server. In addition, other devices required for execution of methods as described in this application may be considered as a part of the infrastructure associated with the server.

The server may provide an interface to other devices including, without limitation, clients, other servers, printers, database servers, print servers, file servers, communication servers, distributed servers, social networks, and the like. Additionally, this coupling and/or connection may facilitate remote execution of program across the network. The networking of some or all of these devices may facilitate parallel processing of a program or method at one or more location without deviating from the scope of the disclosure. In addition, any of the devices attached to the server through an interface may include at least one storage medium capable of storing methods, programs, code and/or instructions. A central repository may provide program instructions to be executed on different devices. In this implementation, the remote repository may act as a storage medium for program code, instructions, and programs.

The software program may be associated with a client that may include a file client, print client, domain client, internet client, intranet client and other variants such as secondary client, host client, distributed client and the like. The client may include one or more of memories, processors, computer readable media, storage media, ports (physical and virtual), communication devices, and interfaces capable of accessing other clients, servers, machines, and devices through a wired or a wireless medium, and the like. The methods, programs, or codes as described herein and elsewhere may be executed by the client. In addition, other devices required for execution of methods as described in this application may be considered as a part of the infrastructure associated with the client.

The client may provide an interface to other devices including, without limitation, servers, other clients, printers, database servers, print servers, file servers, communication servers, distributed servers and the like. Additionally, this coupling and/or connection may facilitate remote execution of program across the network. The networking of some or all of these devices may facilitate parallel processing of a program or method at one or more location without deviating from the scope of the disclosure. In addition, any of the devices attached to the client through an interface may include at least one storage medium capable of storing methods, programs, applications, code and/or instructions. A central repository may provide program instructions to be executed on different devices. In this implementation, the remote repository may act as a storage medium for program code, instructions, and programs.

The methods and systems described herein may be deployed in part or in whole through network infrastructures. The network infrastructure may include elements such as computing devices, servers, routers, hubs, firewalls, clients, personal computers, communication devices, routing devices and other active and passive devices, modules and/or components as known in the art. The computing and/or non-computing device(s) associated with the network infrastructure may include, apart from other components, a storage medium such as flash memory, buffer, stack, RAM, ROM and the like. The processes, methods, program codes, instructions described herein and elsewhere may be executed by one or more of the network infrastructural elements. The methods and systems described herein may be adapted for use with any kind of private, community, or hybrid cloud computing network or cloud computing environment, including those which involve features of software as a service (SaaS), platform as a service (PaaS), and/or infrastructure as a service (IaaS).

The methods, program codes, and instructions described herein and elsewhere may be implemented on a cellular network having multiple cells. The cellular network may either be frequency division multiple access (FDMA) network or code division multiple access (CDMA) network. The cellular network may include mobile devices, cell sites, base stations, repeaters, antennas, towers, and the like. The cell network may be a GSM, GPRS, 3G, EVDO, mesh, or other networks types.

The methods, program codes, and instructions described herein and elsewhere may be implemented on or through mobile devices. The mobile devices may include navigation devices, cell phones, mobile phones, mobile personal digital assistants, laptops, palmtops, netbooks, pagers, electronic books readers, music players and the like. These devices may include, apart from other components, a storage medium such as a flash memory, buffer, RAM, ROM and one or more computing devices. The computing devices associated with mobile devices may be enabled to execute program codes, methods, and instructions stored thereon. Alternatively, the mobile devices may be configured to execute instructions in collaboration with other devices. The mobile devices may communicate with base stations interfaced with servers and configured to execute program codes. The mobile devices may communicate on a peer-to-peer network, mesh network, or other communications network. The program code may be stored on the storage medium associated with the server and executed by a computing device embedded within the server. The base station may include a computing device and a storage medium. The storage device may store program codes and instructions executed by the computing devices associated with the base station.

The computer software, program codes, and/or instructions may be stored and/or accessed on machine readable media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g. USB sticks or keys), floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, and the like.

The methods and systems described herein may transform physical and/or or intangible items from one state to another. The methods and systems described herein may also transform data representing physical and/or intangible items from one state to another.

The elements described and depicted herein, including in flow charts and block diagrams throughout the figures, imply logical boundaries between the elements. However, according to software or hardware engineering practices, the depicted elements and the functions thereof may be implemented on machines through computer executable media having a processor capable of executing program instructions stored thereon as a monolithic software structure, as standalone software modules, or as modules that employ external routines, code, services, and so forth, or any combination of these, and all such implementations may be within the scope of the present disclosure. Examples of such machines may include, but may not be limited to, personal digital assistants, laptops, personal computers, mobile phones, other handheld computing devices, medical equipment, wired or wireless communication devices, transducers, chips, calculators, satellites, tablet PCs, electronic books, gadgets, electronic devices, devices having artificial intelligence, computing devices, networking equipment, servers, routers and the like. Furthermore, the elements depicted in the flow chart and block diagrams or any other logical component may be implemented on a machine capable of executing program instructions. Thus, while the foregoing drawings and descriptions set forth functional aspects of the disclosed systems, no particular arrangement of software for implementing these functional aspects should be inferred from these descriptions unless explicitly stated or otherwise clear from the context. Similarly, it will be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods and/or processes described above, and steps associated therewith, may be realized in hardware, software or any combination of hardware and software suitable for a particular application. The hardware may include a general-purpose computer and/or dedicated computing device or specific computing device or particular aspect or component of a specific computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine-readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software, or any other machine capable of executing program instructions.

Thus, in one aspect, methods described above and combinations thereof may be embodied in computer executable code that, when executing on one or more computing devices, performs the steps thereof. In another aspect, the methods may be embodied in systems that perform the steps thereof, and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

While the disclosure has been disclosed in connection with the preferred embodiments shown and described in detail, various modifications and improvements thereon will become readily apparent to those skilled in the art. Accordingly, the spirit and scope of the present disclosure is not to be limited by the foregoing examples, but is to be understood in the broadest sense allowable by law.

The use of the terms “a” and “an” and “the” and similar referents in the context of describing the disclosure (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the disclosure and does not pose a limitation on the scope of the disclosure unless otherwise claimed. No language in the specification should be construed as indicating any non-claimed element as essential to the practice of the disclosure.

While the foregoing written description enables one of ordinary skill to make and use what is considered presently to be the best mode thereof, those of ordinary skill will understand and appreciate the existence of variations, combinations, and equivalents of the specific embodiment, method, and examples herein. The disclosure should therefore not be limited by the above described embodiment, method, and examples, but by all embodiments and methods within the scope and spirit of the disclosure.

All documents referenced herein are hereby incorporated by reference.

1. An electronic on-line accessible app store comprising:
an electronically searchable catalog of selectable elements representing web presence programs that provide capabilities for enabling online presence of a customer; and
a web presence program maintenance facility that automatically installs a selected portion of the programs and enables at least one web presence-enabling capability for each installed program in response to user confirmation of a selection of a selectable element.

2.-47. (canceled)
